(19) United States
(12) Patent Application Publication
(10) Pub. No.: US 2013/0123166 A1
(43) Pub. Date: May 16, 2013

(54) FABRIC ENHANCERS

(71) Applicant: The Procter & Gamble Company, Cincinnati, OH (US)

(72) Inventors: Yonas Gizaw, West Chester, OH (US); Matthew Lawrence Lynch, Mariemont, OH (US); Frank Hulskotter, Bad Duerkheim (DE); Travis Kyle Hodgdon, Cincinnati, OH (US); Ouidad Benlahmar, Mannheim (DE); Reinhold Joseph Leyrer, Dannstadt (DE); Dieter Hannu Boeckh, Limburgerhof (DE)

(73) Assignee: THE PROCTER & GAMBLE COMPANY, Cincinnati, OH (US)

(21) Appl. No.: 13/671,574

(22) Filed: Nov. 8, 2012

Related U.S. Application Data
(60) Provisional application No. 61/558,701, filed on Nov. 11, 2011.

(51) Int. Cl. C11D 3/37

(52) U.S. Cl. CPC C11D 3/3723; C11D 3/3769
USPC 510/527; 510/515

(57) ABSTRACT

This invention relates to compositions comprising a hydrophobically modified cationic polymer and a fabric softener active, for example a fluid fabric enhancer as well processes of making and using same. Such compositions exhibit improved fabric softener active deposition without exhibiting significantly increased stability negatives. Thus, such compositions are more provide increased softening benefits without the normal phase separation potential.

### FIELD OF INVENTION

This invention relates to fabric enhancer compositions comprising a hydrophobically modified cationic polymer as well processes of making and using same.

### BACKGROUND

Conventional fabric enhancer compositions typically comprise a solvent phase and particulates that comprise a fabric softener active. Such particulates may be vesicles. In addition, a fabric enhancer composition may comprise other materials that include softener actives that are found in the fabric enhancer composition but outside the aforementioned particulates. Regardless of where such softener actives are found, it is desirable to increase the deposition efficiency of such softener actives as this can improve the performance of the fabric enhancer compositions and/or reduce the cost of such fabric enhancer compositions. The deposition efficiency of fabric enhancer compositions is typically increased by the addition of deposition polymers. Unfortunately, as the level of deposition polymer in a fabric enhancer composition is increased the fabric enhancer composition's stability decreases. Eventually, as the level of deposition polymer is increased, the fabric enhancer composition's particulates will bulk separate, which manifests itself as phase separation or a change in the fabric enhancer composition's viscosity will occur, which results in the composition gelling.

Applicants recognized that the phase separation is driven by depletion induced flocculation due to excess deposition aid polymer in the solvent phase of the fabric enhancer composition and that gelling is due to the deposition aid polymer linking particulates. Applicants discovered that the judicious selection of the type and level of the deposition polymer can lead to fabric enhancer compositions that exhibit improved fabric softener active deposition without exhibiting significantly increased stability negatives. Such deposition polymers should have a high adsorption affinity for the aforementioned particulates—thus minimizing the amount of polymer in the fabric enhancer composition's solvent phase—and a low or no tendency to link particulates. Provided the deposition polymer is properly selected, the formulator can use increased levels of such polymer and thus achieve the desired fabric softener active deposition without the aforementioned stability negatives which may include poor silicone deposition, stringiness, and/or poor viscosity.

### SUMMARY OF THE INVENTION

This invention relates to fabric enhancer compositions a hydrophobically modified cationic polymer as well processes of making and using same. Such compositions exhibit improved fabric softener active deposition without exhibiting significantly increased stability negatives.

### BRIEF DESCRIPTION OF THE DRAWINGS

FIG. 1 details the Apparatus A used in the process of the present invention FIG. 2 details the orifice Component 5 of the Apparatus used in the method of the present invention FIG. 3 details the Apparatus B used in the process of the present invention

### DETAILED DESCRIPTION

In the context of the present invention, the terms “a” and “an” mean at “at least one”.

As used herein, the term “situs” includes paper products, fabrics, garments, hard surfaces, hair and skin.

As used herein, Iodine Value is the number of grams of iodine absorbed per 100 grams of the sample material.

As used herein, the terms “include”, “includes” and “including” are meant to be non-limiting.

As used herein, the term “fluid” includes liquid, gel, and paste product forms.

As used herein, the term “situs” includes paper products, fabrics, garments, hard surfaces, hair and skin.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### COMPOSITIONS

In one aspect, a composition comprising, based on total composition weight,
a) at least 0.01%, from about 0.01% to about 2.5%, from about 0.05% to about 2.0%, from about 0.1% to about 1.75%, or from about 0.15% to about 1.70% of a hydrophobically modified cationic polymer wherein said hydrophobically modified cationic polymer has the formula PS wherein P is selected from the group consisting a polyamine, a polyacrylamide, a polyacrylate, a polyvinylpyrrolidone and mixtures thereof and S is at least one hydrophobic moiety and the ratio of monomeric units in P to S is no greater than 10:1 with the provisos that P comprises at least 10 monmeric units, that said hydrophobically modified cationic polymer comprises at least one S and that the value for S is always truncated to an integer; and
b) a fabric softener active,
said composition having a viscosity of less than 2000 cps, from about 15 cps to about 1000 cps, from about 25 cps to about 700 cps, from about 25 cps to about 600 cps, or from about 50 cps to about 200 cps, is disclosed.

In one aspect, of said composition, said fabric softener active is selected from the group consisting of di-tail fabric softener actives, mono-tail fabric softener actives, ion pair fabric softener actives and mixtures thereof.

In one aspect, of said composition, said di-tail fabric softener active, mono-tail fabric softener active and ion pair fabric softener actives are selected from the group consisting of:
a) materials having Formula (1) below

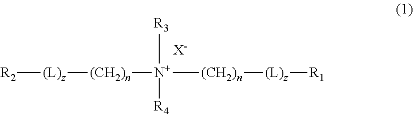

wherein:
   R₁ and R₂ are each independently a C₅-C₂₃ hydrocarbon;
   R₃ and R₄ are each independently selected from the group consisting of C₁-C₄ hydrocarbon, C₁-C₄ hydroxy substituted hydrocarbon, benzyl, —(C₂H₄O)_{y}H where y is an integer from 1 to 10;
   L is selected from the group consisting of —C(O)O—, —(OCH₂CH₂)ₘ—, —(CH₂CH₂O)ₘ—, —C(O)—, —O—(O)C—, —NR—C(O)—, —C(O)—NR— wherein m is 1 or 2 and R is hydrogen or methyl;
   each n is independently an integer from 0 to 4 with the proviso that when L is —C(O)O—, —O—(O)C—, —NR—C(O)—, or —C(O)—NR— the respective n is an integer from 1 to 4; each z is independently 0 or 1; and
   X⁻ is a softener-compatible anion;
b) materials having Formula (2) below

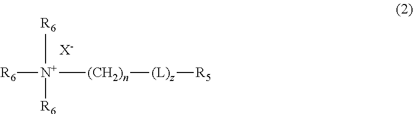

wherein
   R₅ is a C₅-C₂₃ hydrocarbon;
   each R₆ is independently selected from the group consisting of C₁-C₄ hydrocarbon, C₁-C₄ hydroxy substituted hydrocarbon, benzyl, —(C₂H₄O)_{y}H where y is an integer from 1 to 10;
   L is selected from the group consisting of —C(O)O—, —(OCH₂CH₂)ₘ—(CH₂CH₂O)ₘ—, —C(O)—, —O—(O)C—, —NR—C(O)—, —C(O)—NR— wherein m is 1 or 2 and R is hydrogen or methyl;
   each n is independently an integer from 0 to 4 with the proviso that when L is —C(O)O—, —O—(O)C—, —NR—C(O)—, or —C(O)—NR— the respective n is an integer from 1 to 4;
   z is 0 or 1; and
   X⁻ is a softener-compatible anion;
c) materials having Formula (3) below

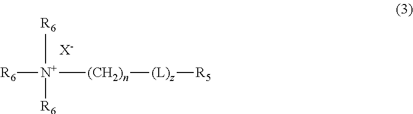

wherein
   R₅ is a C₅-C₂₃ hydrocarbon;
   each R₆ is independently selected from the group consisting of C₁-C₄ hydrocarbon, C₁-C₄ hydroxy substituted hydrocarbon, benzyl, —(C₂H₄O)_{y}H where y is an integer from 1 to 10;
   L is selected from the group consisting of —C(O)O—, —(OCH₂CH₂)ₘ—(CH₂CH₂O)ₘ—, —C(O)—, —O—(O)C—, —NR—C(O)—, —C(O)—NR— wherein m is 1 or 2 and R is hydrogen or methyl;
   each n is independently an integer from 0 to 4 with the proviso that when L is —C(O)O—, —O—(O)C—, —NR—C(O)—, or —C(O)—NR— the respective n is an integer from 1 to 4;
   z is 0 or 1; and
   X⁻ is an anionic surfactant comprising a C₆-C₂₄ hydrocarbon.

In one aspect, of said composition, said di-tail fabric softener active, mono-tail fabric softener active and ion pair fabric softener actives are selected from the group consisting of:
a) materials having Formula (1) below

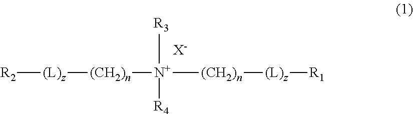

wherein:
   R₁ and R₂ are each independently a C₁₁-C₁₇ hydrocarbon;
   R₃ and R₄ are each independently selected from the group consisting of C₁-C₂ hydrocarbon, C₁-C₂ hydroxy substituted hydrocarbon;
   each n is independently an integer from 1 to 2;
   L is selected from the group consisting of —C(O)O—, —C(O)—, —O—(O)C—;
   each z is independently 0 or 1; and
   X— is a softener-compatible anion, selected from the group consisting of halides, sulfonates, sulfates, and nitrates
b) materials having Formula (2) below

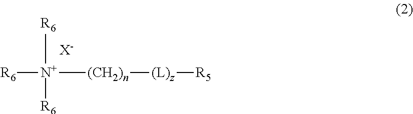

wherein
   R₅ is a C₁₁-C₁₇ hydrocarbon;
   each R₆ is independently selected from the group consisting of C₁-C₂ hydrocarbon, C₁-C₂ hydroxy substituted hydrocarbon;
   n is an integer from 1 to 4;
   L is selected from the group consisting of —C(O)O—, —C(O)—, —O—(O)C—;
   z is 0 or 1; and
   X⁻ is a softener-compatible anion, selected from the group consisting of halides, sulfonates, sulfates, and nitrates;
c) materials having Formula (3) below

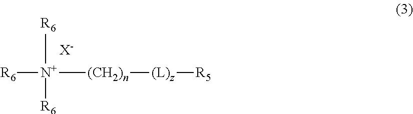

wherein
   R₅ is a C₅-C₂₃ hydrocarbon;
   each R₆ is independently selected from the group consisting of C₁-C₄ hydrocarbon, C₁-C₄ hydroxy substituted hydrocarbon, benzyl, —(C₂H₄O)_{y}H where y is an integer from 1 to 10;
   L is selected from the group consisting of —C(O)O—, —(OCH₂CH₂)ₘ—(CH₂CH₂O)ₘ—, —C(O)—, —O—(O)C—, —NR—C(O)—, —C(O)—NR— wherein m is 1 or 2 and R is hydrogen or methyl;
   each n is independently an integer from 0 to 4 with the proviso that when L is —C(O)O—, —O—(O)C—, —NR—C(O)—, or —C(O)—NR— the respective n is an integer from 1 to 4;
   z is 0 or 1; and
   X— is an anionic surfactant comprising a C₆-C₂₄ hydrocarbon.

In one aspect, of said composition, said di-tail fabric softener active, mono-tail fabric softener active and ion pair fabric softener actives are selected from the group consisting of:
a) materials having Formula (1) below

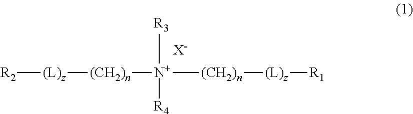

wherein:
   R₁ and R₂ are each independently a C₁₁-C₁₇ hydrocarbon;
   R₃ and R₄ are each independently selected from the group consisting of C₁-C₂ hydrocarbon, C₁-C₂ hydroxy substituted hydrocarbon;
   each n is independently an integer from 1 to 2;
   L is selected from the group consisting of —C(O)O—, —C(O)—, —O—(O)C—;
   each z is independently 0 or 1; and
   X⁻ is a softener-compatible anion, selected from the group consisting of chloride, bromide, methylsulfate, ethylsulfate, and methyl sulfonate
b) materials having Formula (2) below

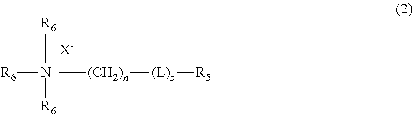

wherein
   R₅ is a C₁₁-C₁₇ hydrocarbon;
   each R₆ is independently selected from the group consisting of C₁-C₂ hydrocarbon, C₁-C₂ hydroxy substituted hydrocarbon;
   n is an integer from 1 to 4;
   L is selected from the group consisting of —C(O)O—, —C(O)—, —O—(O)C—;
   z is 0 or 1; and
   X— is a softener-compatible anion, selected from the group consisting of chloride, bromide, methylsulfate, ethylsulfate, and methyl sulfonate
c). materials having Formula (3) below

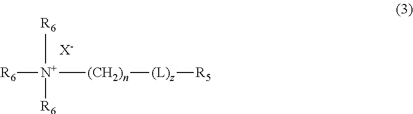

wherein
   R₅ is a C₁₁-C₁₇ hydrocarbon;
   each R₆ is independently selected from the group consisting of C₁-C₂ hydrocarbon, C₁-C₂ hydroxy substituted hydrocarbon;
   n is an integer from 1 to 4;
   L is selected from the group consisting of —C(O)O—, —C(O)—, —O—(O)C—;
   z is 0 or 1; and
   X— is a softener-compatible anion, selected from the group consisting of chloride, bromide, methylsulfate, ethylsulfate, and methyl sulfonate or anionic surfactant comprising a C₆-C₁₈ hydrocarbon.

In one aspect, of said composition, for Formula 3, X— is a C₆-C₂₄ hydrocarbon that is an anionic surfactant.

In one aspect, of said composition, said anionic surfactant is selected from the group consisting of a C₆-C₂₄ alkyl benzene sulfonate surfactant; a C₆-C₂₄ branched-chain and random alkyl sulfate surfactant; a C₆-C₂₄ alkyl alkoxy sulfate surfactant, having an average degree of alkoxylation of from 1 to 30, wherein the alkoxy moiety comprises a C₂ to C₄ chain; a mid-chain branched alkyl sulfate surfactant; a mid-chain branched alkyl alkoxy sulfate surfactant having an average degree of alkoxylation of from 1 to 30, wherein the alkoxy moiety comprises a C₂ to C₄ chain; a C₆-C₂₄ alkyl alkoxy carboxylates comprising an average degree of alkoxylation of from 1 to 5; a C₆-C₂₄ methyl ester sulfonate surfactant, a C₁₀-C₂₄ alpha-olefin sulfonate surfactant, a C₆-C₂₄ sulfosuccinate surfactant, and a mixture thereof.

In one aspect, of said composition, P is a polyamine and each hydrophobic moiety has, independently, the formula

K_{q}W

wherein
K is selected from the group consisting of

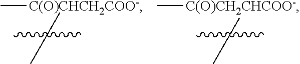

—C(O)O—, —C(O)—, —O—(O)C—, —NR—C(O)—, —C(O)—NR— wherein R is hydrogen or methyl; —(CH₂CH₂O)—, —(CH₂CH₂O)₂—, —(CH₂CH₂O)₃—, —(CH₂CH₂O)₄— and the index q is 0 or 1 and W comprises one of the moieties Z or B; wherein
Z is selected from the group consisting of C₂- to C₂₆-alkyl, C₂- to C₂₆-alkenyl, C₂- to C₂₆-hydroxyalkyl, C₂- to C₂₆-hydroxyalkenyl, C₂- to C₂₆-alkylcarboxyl; and C₂- to C₂₆-aryl, polypropylene, polypropylene oxide, and polyethylene oxide;
B is selected from the group consisting of polyisobutylene, with the proviso that when the hydrophobic moiety is B, the index q equals 1.

In one aspect, of said composition, said polyamine comprises one or more moieties selected from the group consisting of vinyl foramide, vinyl acetate, acrylate, diallyl dimethyl ammonium chloride, vinylpyrrolidone and mixtures thereof.

In one aspect, of said composition, P is a polyamine selected from the group consisting of linear poly(ethyleneimine), branched poly(ethyleneimine), linear poly(vinylamine), branched poly(vinylamine), linear poly(allyamine), branched poly(allyamine) and poly(amidoamine).

In one aspect, of said composition, said polyamine is a branched poly(ethyleneimine).

In one aspect, of said composition, said branched poly(ethyleneimine) has a number average molecular weight of from about 600 Da to 750000 Da, from about 2000 Da to 500000 Da, or from about 25000 Da to 75000 Da.

In one aspect, of said composition, P is a branched poly (ethyleneimine).

In one aspect, of said composition, P is poly(vinylamine).

In one aspect, of said composition, said poly(vinylamine) has a number average molecular weight of from about 10,000 Da to 360000 Da, from about 12000 Da to 200000 Da, or from about 15000 Da to 45000 Da.

In one aspect, of said composition, said hydrophobically modified cationic polymer is selected from the group consisting of hydrophobically modified cationic polymers comprising the following units:

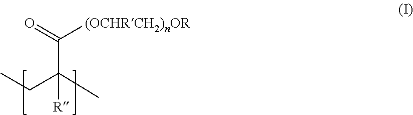

where
R is a C₆-C₅₀ alkyl, C₈-C₃₀ alkyl, or C₁₆-C₂₂ alkyl,
R is H or a C₁-C₄ alkyl, in one aspect H,
R″ is H or methyl,
n is an integer from 0 to 100, 3 to 50, or from 10 to 25;

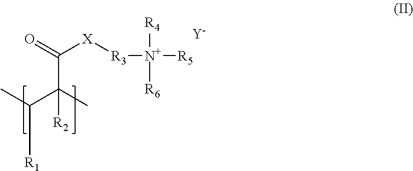

where
R₁ is H or a C₁-C₄ alkyl, R₁ is H or methyl, or R₁ is H
R₂ is H or methyl,
R₃ is a C₁-C₄ alkyl, linear C₁-C₄ alkyl, or linear C₃ alkyl R₄, and R₅ are each independently H or a C₁-C₃₀ alkyl,
R₆ is H or a C₁-C₂ alkyl, or methyl,
X is —O— or —NH— and
Y is a suitable counter ion, in one aspect, Y is Cl, Br, I, hydrogensulfate or methosulfate.
or where
R₁ is H or a C₁-C₄ alkyl, or H or methyl
R₂ is H or methyl
R₃ is a C₁-C₄ linear alkyl, or C₃ linear alkyl
R₄, and R₅ are each independently H or a C₁-C₃₀ alkyl,
R₆ is methyl
when at least one of R₄ and R₅ are a C₆-C₃₀ alkyl the repeat unit is hydrophobically modified, or R₄ or R₅ is a C₁₂-C₁₈ alkyl and the remaining R₄ or R₅ is methyl with proviso that total number of carbon atoms in R₄ and R₅, does not exceed 24
X is —O— or —NH— and
Y is Cl; Br; I; hydrogensulfate or methosulfate.
or where
R₁ is H or a C₁-C₄ alkyl, or hydrogen
R₂ is H or methyl,
R₃ is a C₁-C₄ alkyl, linear C₁-C₄ alkyl or linear C₃ alkyl.
R₄, and R₅ are each independently H or a C₁-C₃₀ alkyl,
R₆ is H or a C₁-C₂ alkyl.
when R₄ and R₅ are H or a C₁-C₅ alkyl the repeat unit is not hydrophobically modified, in one aspect, R₄ and R₅ are methyl
X is —O— or —NH— and
Y is a suitable counter ion; in one aspect, Y⁻ is Cl; Br; I; hydrogensulfate or methosulfate.

In one aspect, of said composition, for Structure II at least one of R₄ and R₅ are a C₆-C₃₀ alkyl and the total number of carbon atoms in R₄ and R₅ does not exceed 24.

In one aspect, of said composition, for Structure II one of R₄ and R₅ is a C₁₂-C₁₈ alkyl and the total number of carbon atoms in R₄ and R₅, does not exceed 24.

In one aspect, of said composition, for Structure II one of R₄ and R₅ is a C₁₂-C₁₈ alkyl and the remaining R₄ or R₅ is methyl.

In one aspect, of said composition, for Structure II R₄ and R₅ are H or a C₁-C₅ alkyl, or R₄ and R₅ are methyl.

Suitable hydrophobically modified cationic polymers as disclosed in present specification may be made in accordance with the teachings of this specification or purchased from the BASF Corporation of Ludwigshafen am Rhein (Rhineland-Palatinate, Germany).

In one aspect, the fabric softener active used in the compositions of the present invention may have Iodine Values (herein referred to as “IV”) of from about 70 to about 140. In one suitable embodiment, the IV range is from about zero to about 70. In one aspect, the fabric softener active is made with fatty acid precursors with a range of IV from about zero to about 40. In another aspect, the compositions of the present invention comprise an IV range of from at least about 40 to about 70.

In one aspect, the compositions disclosed herein have the following stability (no visual separation) at, at least 6 weeks, from about 24 months to about 1 month, from about 22 months to about 2 months, from about 20 months to about 4 months, or even from about 18 months to about 6 months.

In one aspect, said fabric softening active (FSA) may be a mixture of more than one FSAs.

In one aspect, the compositions disclosed herein may comprise, based on total composition weight, at least about 1%, at least about 2%, at least about 3%, at least about 5%, at least about 10%, and at least about 12%, and less than about 90%, less than about 40%, less than about 30%, less than about 20%, less than about 18%, less than about 15%, of said FSA or mixture of FSAs.

In one aspect, composition disclosed herein may be in the form of a powder/granule, a bar, a pastille, foam, flakes, a fluid, a dispersible substrate, or as a coating on a dryer added fabric softener sheet.

In one aspect, the compositions disclosed herein may be fluid fabric enhancers.

In one aspect, the fluid fabric enhancer composition further comprises a pH modifier in an appropriate amount to make the fabric enhancer composition acidic, having a pH in the range of below about 6, alternatively below about, alternatively from about 2 to about 5, alternatively from 2.5 to 4. Suitable levels of pH modifiers are from about zero % to about 4% by weight of the fabric enhancer composition, alternatively from about 0.01% to about 2%. Suitable pH modifiers comprise hydrogen chloride, citric acid, other organic or inorganic acids, and mixtures thereof.

In one aspect, the compositions disclosed herein comprise one or more actives selected from the group consisting of an additional additive.

In one aspect, the compositions disclosed herein may be fluid fabric enhancers that may comprise one or more additional additives selected from the group consisting of silicone, perfume and/or a benefit agent delivery system such as a perfume microcapsule.

### Additional Additives

Those of ordinary skill in the art will recognize that additional additives are optional but are often used in compositions of the type disclosed herein, for example fluid fabric enhancers. Thus such compositions may comprise an additional additive comprising: ingredients selected from the group comprising, additional softener actives, silicone compounds, structurants, deposition aids, perfumes, benefit agent delivery systems, dispersing agents, stabilizers, pH control agents, colorants, brighteners, dyes, odor control agent, solvents, soil release polymers, preservatives, antimicrobial agents, chlorine scavengers, anti-shrinkage agents, fabric crisping agents, spotting agents, anti-oxidants, anti-corrosion agents, bodying agents, drape and form control agents, smoothness agents, static control agents, wrinkle control agents, sanitization agents, disinfecting agents, germ control agents, mold control agents, mildew control agents, antiviral agents, anti-microbials, drying agents, stain resistance agents, soil release agents, malodor control agents, fabric refreshing agents, chlorine bleach odor control agents, dye fixatives, dye transfer inhibitors, color maintenance agents, color restoration/rejuvenation agents, anti-fading agents, whiteness enhancers, anti-abrasion agents, wear resistance agents, fabric integrity agents, anti-wear agents, defoamers and anti-foaming agents, rinse aids, UV protection agents, sun fade inhibitors, insect repellents, anti-allergenic agents, enzymes, flame retardants, water proofing agents, fabric comfort agents, water conditioning agents, shrinkage resistance agents, stretch resistance agents, thickeners, chelants, electrolytes and mixtures thereof. Such additives are known and can be included in the present formulation as needed. In one aspect, the fabric enhancer is free or substantially free of any of the aforementioned additives.

Suitable electrolytes for use in the present invention include alkali metal and alkaline earth metal salts such as those derived from potassium, sodium, calcium, magnesium.

Silicones—Suitable silicones comprise Si—O moieties and may be selected from (a) non-functionalized siloxane polymers, (b) functionalized siloxane polymers, and combinations thereof. The molecular weight of the organosilicone is usually indicated by the reference to the viscosity of the material. In one aspect, the organosilicones may comprise a viscosity of from about 10 to about 2,000,000 centistokes at 25° C. In another aspect, suitable organosilicones may have a viscosity of from about 10 to about 800,000 centistokes at 25° C.

Suitable organosilicones may be linear, branched or cross-linked. In one aspect, the organosilicones may comprise of silicone resins. Silicone resins are highly cross-linked polymeric siloxane systems. The cross-linking is introduced through the incorporation of trifunctional and tetrafunctional silanes with monofunctional or difunctional, or both, silanes during manufacture of the silicone resin.

Silicone materials and silicone resins in particular, can conveniently be identified according to a shorthand nomenclature system known to those of ordinary skill in the art as “MDTQ” nomenclature. Under this system, the silicone is described according to presence of various siloxane monomer units which make up the silicone. Briefly, the symbol M denotes the monofunctional unit (CH₃)₃SiO_{0.5}; D denotes the difunctional unit (CH₃)₂SiO; T denotes the trifunctional unit (CH₃)SiO_{1.5}; and Q denotes the quadra- or tetra-functional unit SiO₂. Primes of the unit symbols (e.g. M′, D′, T′, and Q′) denote substituents other than methyl, and must be specifically defined for each occurrence.

In one aspect, silicone resins for use in the compositions of the present invention include, but are not limited to MQ, MT, MTQ, MDT and MDTQ resins. In one aspect, Methyl is a highly suitable silicone substituent. In another aspect, silicone resins are typically MQ resins, wherein the M:Q ratio is typically from about 0.5:1.0 to about 1.5:1.0 and the average molecular weight of the silicone resin is typically from about 1000 to about 10,000.

Other modified silicones or silicone copolymers are also useful herein. Examples of these include silicone-based quaternary ammonium compounds (Kennan quats) disclosed in U.S. Pat. Nos. 6,607,717 and 6,482,969; end-terminal quaternary siloxanes; silicone aminopolyalkyleneoxide block copolymers disclosed in U.S. Pat. Nos. 5,807,956 and 5,981,681; hydrophilic silicone emulsions disclosed in U.S. Pat. No. 6,207,782; and polymers made up of one or more crosslinked rake or comb silicone copolymer segments disclosed in U.S. Pat. No. 7,465,439. Additional modified silicones or silicone copolymers useful herein are described in US Patent Application Nos. 2007/0286837A1 and 2005/0048549A1.

In alternative embodiments of the present invention, the above-noted silicone-based quaternary ammonium compounds may be combined with the silicone polymers described in U.S. Pat. Nos. 7,041,767 and 7,217,777 and US Application number 2007/0041929A1.

In one aspect, the organosilicone may comprise a non-functionalized siloxane polymer that may have Formula (XXIV) below, and may comprise polyalkyl and/or phenyl silicone fluids, resins and/or gums.

[R₁R₂R₃SiO_{1/2}]ₙ[R₄R₄SiO_{2/2}]ₘ[R₄SiO_{3/2}]ⱼ Formula (XXIV)

wherein:
i) each R₁, R₂, R₃ and R₄ may be independently selected from the group consisting of H, —OH, C₁-C₂₀ alkyl, C₁-C₂₀ substituted alkyl, C₆-C₂₀ aryl, C₆-C₂₀ substituted aryl, alkylaryl, and/or C₁-C₂₀ alkoxy, moieties;
ii) n may be an integer from about 2 to about 10, or from about 2 to about 6; or 2; such that n=j+2;
iii) m may be an integer from about 5 to about 8,000, from about 7 to about 8,000 or from about 15 to about 4,000;
iv) j may be an integer from 0 to about 10, or from 0 to about 4, or 0;

In one aspect, R₂, R₃ and R₄ may comprise methyl, ethyl, propyl, C₄-C₂₀ alkyl, and/or C₆-C₂₀ aryl moieties. In one aspect, each of R₂, R₃ and R₄ may be methyl. Each R₁ moiety blocking the ends of the silicone chain may comprise a moiety selected from the group consisting of hydrogen, methyl, methoxy, ethoxy, hydroxy, propoxy, and/or aryloxy.

As used herein, the nomenclature SiO“n”/2 represents the ratio of oxygen and silicon atoms. For example, SiO_{1/2} means that one oxygen is shared between two Si atoms. Likewise SiO_{2/2} means that two oxygen atoms are shared between two Si atoms and SiO_{3/2} means that three oxygen atoms are shared are shared between two Si atoms.

In one aspect, the organosilicone may be polydimethylsiloxane, dimethicone, dimethiconol, dimethicone crosspolymer, phenyl trimethicone, alkyl dimethicone, lauryl dimethicone, stearyl dimethicone and phenyl dimethicone. Examples include those available under the names DC 200 Fluid, DC 1664, DC 349, DC 346G available from Dow Corning® Corporation, Midland, Mich., and those available under the trade names SF1202, SF1204, SF96, and Viscasil® available from Momentive Silicones, Waterford, N.Y.

In one aspect, the organo silicone may comprise a cyclic silicone. The cyclic silicone may comprise a cyclomethicone of the formula [(CH₃)₂SiO]ₙ where n is an integer that may range from about 3 to about 7, or from about 5 to about 6.

In one aspect, the organosilicone may comprise a functionalized siloxane polymer. Functionalized siloxane polymers may comprise one or more functional moieties selected from the group consisting of amino, amido, alkoxy, hydroxy, polyether, carboxy, hydride, mercapto, sulfate phosphate, and/or quaternary ammonium moieties. These moieties may be attached directly to the siloxane backbone through a bivalent alkylene radical, (i.e., “pendant”) or may be part of the backbone. Suitable functionalized siloxane polymers include materials selected from the group consisting of aminosilicones, amidosilicones, silicone polyethers, silicone-urethane polymers, quaternary ABn silicones, amino ABn silicones, and combinations thereof.

In one aspect, the functionalized siloxane polymer may comprise a silicone polyether, also referred to as “dimethicone copolyol.” In general, silicone polyethers comprise a polydimethylsiloxane backbone with one or more polyoxyalkylene chains. The polyoxyalkylene moieties may be incorporated in the polymer as pendent chains or as terminal blocks. Such silicones are described in USPA 2005/0098759, and U.S. Pat. Nos. 4,818,421 and 3,299,112. Exemplary commercially available silicone polyethers include DC 190, DC 193, FF400, all available from Dow Corning® Corporation, and various Silwet® surfactants available from Momentive Silicones.

In another aspect, the functionalized siloxane polymer may comprise an aminosilicone. Suitable aminosilicones are described in U.S. Pat. Nos. 7,335,630 B2, 4,911,852, and USPA 2005/0170994A1. In one aspect the aminosilicone may be that described in U.S. PA 61/221,632. In another aspect, the aminosilicone may comprise the structure of Formula (XXV):

[R₁R₂R₃SiO_{1/2}]ₙ[(R₄Si(X—Z)O_{2/2}]ₖ[R₄R₄SiO_{2/2}]ₘ[R₄SiO_{3/2}]ⱼ Formula (XXV)
wherein
i. R₁, R₂, R₃ and R₄ may each be independently selected from H, OH, C₁-C₂₀ alkyl, C₁-C₂₀ substituted alkyl, C₆-C₂₀ aryl, C₆-C₂₀ substituted aryl, alkylaryl, and/or C₁-C₂₀ alkoxy;
ii. Each X may be independently selected from a divalent alkylene radical comprising 2-12 carbon atoms, —(CH₂)s— wherein s may be an integer from about 2 to about 10; —CH₂—CH(OH)—CH₂—; and/or

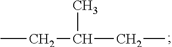

iii. Each Z may be independently selected from —N(R₅)₂; —

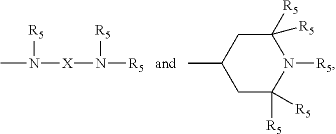

wherein each R₅ may be selected independently selected from H, C₁-C₂₀ alkyl; and A⁻ may be a compatible anion. In one aspect, A⁻ may be a halide;
iv. k may be an integer from about 3 to about 20, from about 5 to about 18 more or even from about 5 to about 10;
v. m may be an integer from about 100 to about 2,000, or from about 150 to about 1,000;
vi. n may be an integer from about 2 to about 10, or about 2 to about 6, or 2, such that n=j+2; and
vii. j may be an integer from 0 to about 10, or from 0 to about 4, or 0;
In one aspect, R₁ may comprise —OH. In this aspect, the organosilicone is amidomethicone.

Exemplary commercially available aminosilicones include DC 8822, 2-8177, and DC-949, available from Dow Corning® Corporation, and KF-873, available from Shin-Etsu Silicones, Akron, Ohio.

In one aspect, the organosilicone may comprise amine ABn silicones and quat ABn silicones. Such organosilicones are generally produced by reacting a diamine with an epoxide. These are described, for example, in U.S. Pat. Nos. 6,903,061 B2, 5,981,681, 5,807,956, 6,903,061 and 7,273,837. These are commercially available under the trade names Magnasoft® Prime, Magnasoft® JSS, Silsoft® A-858 (all from Momentive Silicones).

In another aspect, the functionalized siloxane polymer may comprise silicone-urethanes, such as those described in U.S. PA 61/170,150. These are commercially available from Wacker Silicones under the trade name SLM-21200®.

When a sample of organosilicone is analyzed, it is recognized by the skilled artisan that such sample may have, on average, the non-integer indices for Formula (XXIV) and (XXV) above, but that such average indices values will be within the ranges of the indices for Formula (XXIV) and (XXV) above.

In one aspect of the compositions disclosed herein comprise a perfume and or benefit agent delivery system. As used herein the term “perfume” is used to indicate any odoriferous material that is subsequently released into the aqueous bath and/or onto fabrics contacted therewith. Suitable benefit agent delivery systems, methods of making benefit agent delivery systems and the uses of benefit agent delivery systems are disclosed in USPA 2007/0275866 A1. Such benefit agent delivery systems include:

I. Polymer Assisted Delivery (PAD):

This benefit agent delivery technology uses polymeric materials to deliver benefit agents (e.g., perfumes). Examples of PAD include employment of classical coacervation, water soluble or partly soluble to insoluble charged or neutral polymers, liquid crystals, hot melts, hydrogels, perfumed plastics, microcapsules, nano- and micro-latexes, polymeric film formers, and polymeric absorbents, polymeric adsorbents, etc. Further, PAD includes but is not limited to:

a.) Matrix Systems: The benefit agent is dissolved or dispersed in a polymer matrix or particle. Perfumes, for example, may be 1) dispersed into the polymer prior to formulating into the product or 2) added separately from the polymer during or after formulation of the product. Examples include those with amine functionality, which may be used to provide benefits associated with amine-assisted delivery (AAD) and/or polymer-assisted delivery (PAD) and/or amine-reaction products (ARP).

b.) Reservoir Systems: Reservoir systems are also known as a core-shell system (e.g., perfume microcapsules). In such a system, the benefit agent is surrounded by a benefit agent release controlling membrane, which may serve as a protective shell. Suitable shell materials include reaction products of one or more amines with one or more aldehydes, such as urea cross-linked with formaldehyde or gluteraldehyde, melamine cross-linked with formaldehyde; gelatin-polyphosphate coacervates optionally cross-linked with gluteraldehyde; gelatin-gum Arabic coacervates; cross-linked silicone fluids; polyamine reacted with polyisocyanates, polyamines reacted with epoxides, polyvinyl alcohol cross linked with gluteraldehyde, polydivinyl chloride, polyacrylate, in one aspect said polyacrylate based materials may comprise polyacrylate formed from methylmethacrylate/dimethylaminomethyl methacrylate, polyacrylate formed from amine acrylate and/or methacrylate and strong acid, polyacrylate formed from carboxylic acid acrylate and/or methacrylate monomer and strong base, polyacrylate formed from an amine acrylate and/or methacrylate monomer and a carboxylic acid acrylate and/or carboxylic acid methacrylate monomer, and mixtures thereof.

Suitable core materials include perfume compositions, and/or perfume raw materials, Suitable perfume compositions may comprise enduring perfumes, such as perfume raw materials that have a cLogP greater than about 2.5 and a boiling point greater than about 250° C. Further, suitable perfume compositions may comprise blooming perfumes that comprise perfume raw materials that have a cLogP of greater than about 3 and a boiling point of less than about 260° C.

Suitable core materials being stabilized, emulsified, in the solvent systems with organic or inorganic materials, organic materials can be polymers of anionic, non-ionic nature or cationic nature, like polyacrylates, polyvinyl alcohol. Suitable processes to make core shell systems include coating, extrusion, spray drying, interfacial polymerization, polycondensation, simple coacervation, complex coacervation, free radical polymerization, in situ emulsion polymerization, matrix polymerization and combinations thereof.

Suitable characteristics for core shell systems include:
a) a shell thickness of from about 20 nm to about 500 nm, from about 40 nm to about 250 nm, or from about 60 nm to about 150 nm;
b) a shell core ratio of from about 5:95 to about 50:50, from about 10:90 to about 30:70, or from about 10:90 to about 15:85;
c) a fracture strength of from about 0.1 MPa to about 16 MPa, from about 0.5 MPa to about 8 MPa, or even from about 1 MPa to about 3 MPa; and
d) an average particle size of from about 1 micron to about 100 microns, from about 5 microns to about 80 microns, or even from about 15 microns to about 50 microns.

Suitable deposition and/or retention enhancing coatings that may be applied to the core shell systems include cationic polymers such as polysaccharides including, but not limited to, cationically modified starch, cationically modified guar, polysiloxanes, poly diallyl dimethyl ammonium halides, copolymers of poly diallyl dimethyl ammonium chloride and vinyl pyrrolidone, acrylamides, imidazoles, imidazolinium halides, imidazolium halides, poly vinyl amine, copolymers of poly vinyl amine and N-vinyl formamide and mixtures thereof. In another aspect, suitable coatings may be selected from the group consisting of polyvinylformaldehyde,

partially hydroxylated polyvinylformaldehyde, polyvinylamine, polyethyleneimine, ethoxylated

polyethyleneimine, polyvinylalcohol, polyacrylates, and combinations thereof.

Suitable methods of physically reducing any residual type materials may be employed, such as centrifugation, to remove undesirable materials. Suitable methods of chemically reducing any residual type materials may also be employed, such as the employment of scavengers, for example formaldehyde scavengers including sodium bisulfite, urea, ethylene urea, cysteine, cysteamine, lysine, glycine, serine, carnosine, histidine, glutathione, 3,4-diaminobenzoic acid, allantoin, glycouril, anthranilic acid, methyl anthranilate, methyl 4-aminobenzoate, ethyl acetoacetate, acetoacetamide, malonamide, ascorbic acid, 1,3-dihydroxyacetone dimer, biuret, oxamide, benzoguanamine, pyroglutamic acid, pyrogallol, methyl gallate, ethyl gallate, propyl gallate, triethanol amine, succinamide, thiabendazole, benzotriazol, triazole, indoline, sulfanilic acid, oxamide, sorbitol, glucose, cellulose, poly(vinyl alcohol), partially hydrolyzed poly(vinylformamide), poly(vinyl amine), poly(ethylene imine), poly(oxyalkyleneamine), poly(vinyl alcohol)-co-poly(vinyl amine), poly(4-aminostyrene), poly(1-lysine), chitosan, hexane diol, ethylenediamine-N,N′-bisacetoacetamide, N-(2-ethylhexyl)acetoacetamide, 2-benzoylacetoacetamide, N-(3-phenylpropyl)acetoacetamide, lilial, helional, melonal, triplal, 5,5-dimethyl-1,3-cyclohexanedione, 2,4-dimethyl-3-cyclohexenecarboxaldehyde, 2,2-dimethyl-1,3-dioxan-4,6-dione, 2-pentanone, dibutyl amine, triethylenetetramine, ammonium hydroxide, benzylamine, hydroxycitronellol, cyclohexanone, 2-butanone, pentane dione, dehydroacetic acid, or a mixture thereof.

III. Amine Assisted Delivery (AAD):

The amine-assisted delivery technology approach utilizes materials that contain an amine group to increase perfume deposition or modify perfume release during product use. There is no requirement in this approach to pre-complex or pre-react the perfume raw material(s) and the amine prior to addition to the product. In one aspect, amine-containing AAD materials suitable for use herein may be non-aromatic; for example, polyalkylimine, such as polyethyleneimine (PEI), or polyvinylamine (PVAm), or aromatic, for example, anthranilates. Such materials may also be polymeric or non-polymeric. In one aspect, such materials contain at least one primary amine. In another aspect, a material that contains a heteroatom other than nitrogen, for example sulfur, phosphorus or selenium, may be used as an alternative to amine compounds. In yet another aspect, the aforementioned alternative compounds can be used in combination with amine compounds. In yet another aspect, a single molecule may comprise an amine moiety and one or more of the alternative heteroatom moieties, for example, thiols, phosphines and selenols.

IV. Pro-Perfume (PP):

This technology refers to perfume technologies that result from the reaction of perfume materials with other substrates or chemicals to form materials that have a covalent bond between one or more PRMs and one or more carriers. The PRM is converted into a new material called a pro-PRM (i.e., pro-perfume), which then may release the original PRM upon exposure to a trigger such as water or light. Nonlimiting examples of pro-perfumes include Michael adducts (e.g., beta-amino ketones), aromatic or non-aromatic imines (Schiffs Bases), oxazolidines, beta-keto esters, and orthoesters. Another aspect includes compounds comprising one or more beta-oxy or beta-thio carbonyl moieties capable of releasing a PRM, for example, an alpha, beta-unsaturated ketone, aldehyde or carboxylic ester.

a.) Amine Reaction Product (ARP): For purposes of the present application, ARP is a subclass or species of PP. One may also use “reactive” polymeric amines in which the amine functionality is pre-reacted with one or more PRMs, typically PRMs that contain a ketone moiety and/or an aldehyde moiety, to form an amine reaction product (ARP). Typically, the reactive amines are primary and/or secondary amines, and may be part of a polymer or a monomer (non-polymer). Such ARPs may also be mixed with additional PRMs to provide benefits of polymer-assisted delivery and/or amine-assisted delivery. Nonlimiting examples of polymeric amines include polymers based on polyalkylimines, such as polyethyleneimine (PEI), or polyvinylamine (PVAm). Nonlimiting examples of monomeric (non-polymeric) amines include hydroxy]amines, such as 2-aminoethanol and its alkyl substituted derivatives, and aromatic amines such as anthranilates. The ARPs may be premixed with perfume or added separately in leave-on or rinse-off applications. In another aspect, a material that contains a heteroatom other than nitrogen, for example oxygen, sulfur, phosphorus or selenium, may be used as an alternative to amine compounds. In yet another aspect, the aforementioned alternative compounds can be used in combination with amine compounds. In yet another aspect, a single molecule may comprise an amine moiety and one or more of the alternative heteroatom moieties, for example, thiols, phosphines and selenols.

Suitable perfume delivery systems, methods of making certain perfume delivery systems and the uses of such perfume delivery systems are disclosed in USPA 2007/0275866 A1. In one aspect, the fabric care composition comprises from about 0.01% to about 5%, alternatively from about 0.5% to about 3%, or from about 0.5% to about 2%, or from about 1% to about 2% neat perfume by weight of the fabric care composition.

In one aspect, the compositions of the present invention comprises perfume oil encapsulated in a perfume microcapsule (PMC), preferable a friable PMC. In another aspect, the perfume microcapsule comprises a friable microcapsule. In another aspect, the PMC shell may comprise an aminoplast copolymer, esp. melamine-formaldehyde or urea-formaldehyde or cross-linked melamine formaldehyde or the like. In another aspect, the PMC shell may be a shell that comprises an acrylic material. Capsules may be obtained from Appleton Papers Inc., of Appleton, Wisconsin USA. Formaldehyde scavengers may also be used.

In one aspect, the compositions of the present invention are free or substantially free of detersive surfactants. In one aspect, the composition comprises less than about 5% of a detersive surfactant, alternatively less than about 2%, alternatively less than about 1%, alternatively less than 0.5%, by weight of the composition.

In another aspect, the fabric enhancers of the present invention are free or substantially free of biological active (cosmetic or pharmaceutical) agents which are suited towards treating the symptoms and/or disorders of living organisms, notably of the skin and hair. Further, in one aspect, the composition is free of materials which are oxygen sensitive (e.g. agents such as retinol).

### Processes of Making

The compositions of the present invention may be made by combining a hydrophobically modified cationic polymer wherein said hydrophobically modified cationic polymer has the formula PSₓ wherein P is selected from the group consisting a polyamine, a polyacrylamide, a polyacrylate, a polyvinylpyrrolidone and mixtures thereof and S is a hydrophobic moiety and the index x is an integer from 1 to an integer that is equal to the sum of the nitrogen atoms and oxygen atoms in P and fabric softener active.

In one aspect, the compositions disclosed herein may be made by a process for making a fabric enhancing composition using an apparatus for mixing the liquid fabric enhancing composition components by producing shear, turbulence and/or cavitation. It should be understood that, in certain aspects, the ability of the process to induce shear may not only be useful for mixing, but may also be useful for dispersion of solid particles in liquids, liquid in liquid dispersions and in breaking up solid particles. In certain aspects, the ability of the process to induce shear and/or produce cavitation may also be useful for droplet and/or vesicle formation.

In one aspect, the process of making a fluid composition comprises:

combining a plurality of fluids in an apparatus, said apparatus comprising: one or more inlets (1A) and one or more inlets (1B), said one or more inlets (1A) and said one or more inlets (1B) being in fluid communication with one or more suitable liquid transporting devices; a pre-mixing chamber (2), the pre-mixing chamber (2) having an upstream end (3) and a downstream end (4), the upstream end (3) of the pre-mixing chamber (2) being in liquid communication with said one or more inlets (1A) and said one or more inlets (1B); an orifice component (5), the orifice component (5) having an upstream end (6) and a downstream end (7), the upstream end of the orifice component (6) being in liquid communication with the downstream end (4) of the pre-mixing chamber (2), wherein the orifice component (5) is configured to spray liquid in a jet and produce shear, turbulence and/or cavitation in the liquid; a secondary mixing chamber (8), the secondary mixing chamber (8) being in liquid communication with the downstream end (7) of the orifice component (5); at least one outlet (9) in liquid communication with the secondary mixing chamber (8) for discharge of liquid following the production of shear, turbulence and/or cavitation in the liquid, the at least one outlet (9) being located at the downstream end of the secondary mixing chamber (8); the orifice component (5) comprising at least two orifice units, (10) and (11) arranged in series to one another and each orifice unit comprises an orifice plate (12) comprising at least one orifice (13), an orifice chamber (14) located upstream from the orifice plate (12) and in liquid communication with the orifice plate (12); and wherein neighboring orifice plates are distinct from each other;

wherein said combining is achieved by applying a force from about 0.1 bar to about 50 bar, from about 0.5 bar to about 10 bar, from about 1 bar to about 5 bar to said plurality of fluids, said force being applied by said transportation devices

then applying a shearing energy of from about 10 g/cm s² to about 1,000,000 g/cm s², from about 50 g/cm s² to about 500,000 g/cm s² from about 100 g/cm s² to about 100,000 g/cm s², for a residence time from about 0.1 seconds to about 10 minutes, from about 1 second to about 1 minute, from about 2 seconds to about 30 seconds to said combined plurality of fluids.

optionally cooling said combined plurality of fluids, during and/or after said shearing step, to temperatures from about 5° C. to about 45° C., from about 10° C. to about 35° C., from about 15° C. to about 30° C., from about 20° C. to about 25° C.

optionally, adding a electrolyte, in one aspect, a fluid comprising a electrolyte, to said combined plurality of fluids during said combining and/or said shearing step.

optionally, adding in one or more adjunct ingredients to said plurality of fluids and/or combined plurality of fluids.

optionally, recycling said combined plurality of fluids through one or more portions of said process is disclosed.

In one aspect, the process comprises adding in one or more adjunct ingredients useful for fabric conditioning.

In one aspect of said process, the fabric enhancing active is present between 50% and 100% by weight of the fabric enhancing active composition.

Apparatus A

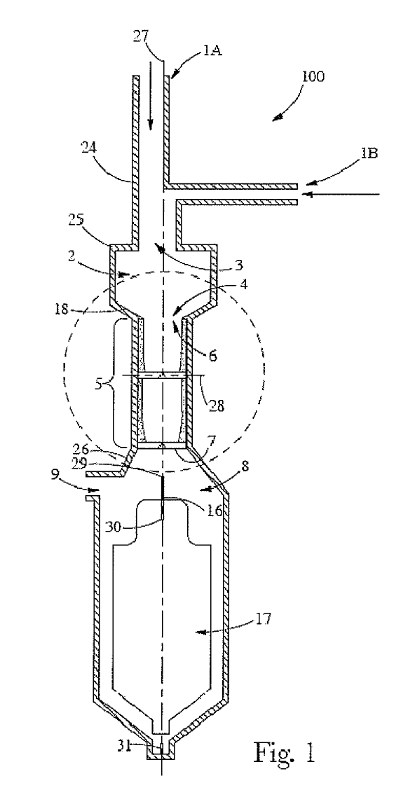

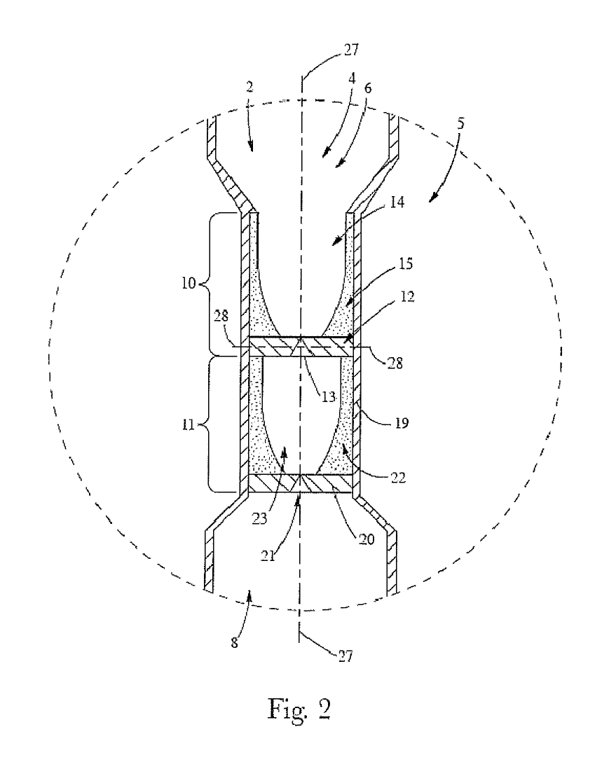

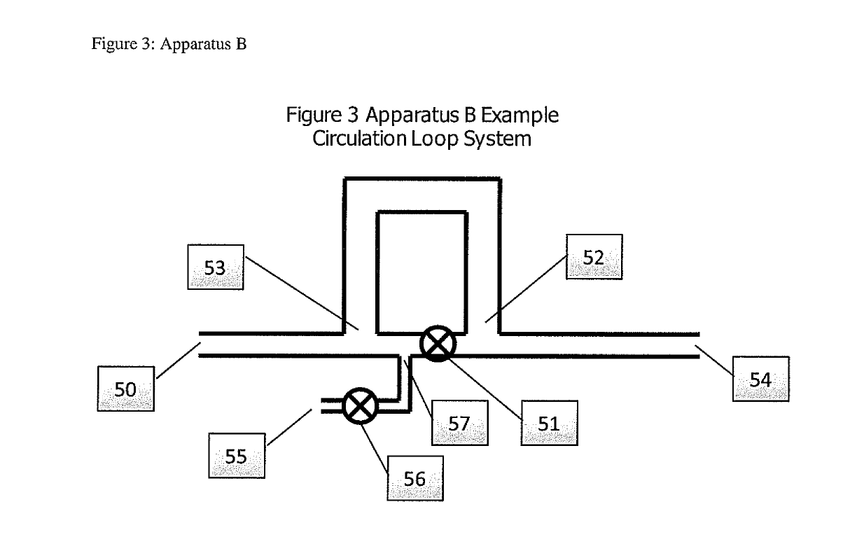

FIG. 1 shows one aspect of an apparatus A for mixing liquids by producing shear, turbulence and/or cavitation, said apparatus comprising, at least one inlet 1A and a pre-mixing chamber 2. The pre-mixing chamber has an upstream end 3 and a downstream end 4, the upstream end 4 being in liquid communication with the at least one inlet 1A. The Apparatus A also comprises an orifice component 5, the orifice component 5 having an upstream end 6 and a downstream end 7. The upstream end of the orifice component 6 is in liquid communication with the downstream end 4 of the pre-mixing chamber 2, and the orifice component 5 is configured to spray liquid in the form of a jet and produce shear or cavitation in the liquid. A secondary mixing chamber 8 is in liquid communication with the downstream end 7 of the orifice component 5. At least one outlet 9 communicates with the secondary mixing chamber 8 for discharge of liquid following the production of shear, turbulence or cavitation in the liquid, and is located at the downstream end of the secondary mixing chamber 8.

A liquid(s) can be introduced into the inlet 1A at a desired operating pressure. The liquid can be introduced at a desired operating pressure using standard liquid pumping devices. The liquid flows from the inlet into the pre-mix chamber 2 and then into the orifice component 5. The liquid will then exit the orifice component 5 into the secondary mixing chamber 8, before exiting the Apparatus A through the outlet 9.

As can be seen in FIG. 2, the orifice component comprises at least two orifice units 10 and 11 arranged in series to one another. Each orifice unit comprises an orifice plate 12 comprising at least one orifice 13, an orifice chamber 14 located upstream from the orifice plate and in liquid communication with the orifice plate. In one aspect, the orifice unit 10 further comprises an orifice bracket 15 located adjacent to and upstream from the orifice plate 12, the walls of the orifice bracket 15 defining a passageway through the orifice chamber 14.

In another aspect, the Apparatus A comprises at least 5 orifice units arranged in series. In yet another aspect, the Apparatus A comprises at least 10 orifice units arranged in series.

The Apparatus A may, but need not, further comprise at least one blade 16, such as a knife-like blade, disposed in the secondary mixing chamber 8 opposite the orifice component 5.

The components of the present Apparatus A can include an injector component, an inlet housing 24, a pre-mixing chamber housing 25, an orifice component housing 19, the orifice component 5, a secondary mixing chamber housing 26, a blade holder 17, and an adjustment component 31 for adjusting the distance between the tip of blade 16 and the discharge of the orifice component 5. It may also be desirable for there to be a throttling valve (which may be external to the Apparatus A) that is located downstream of the secondary mixing chamber 8 to vary the pressure in the secondary mixing chamber 8. The inlet housing 24, pre-mixing chamber housing 25, and secondary mixing chamber housing 26 can be in any suitable configurations. Suitable configurations include, but are not limited to cylindrical, configurations that have elliptical, or other suitable shaped cross-sections. The configurations of each of these components need not be the same. In one aspect, these components generally comprise cylindrical elements that have substantially cylindrical inner surfaces and generally cylindrical outer surfaces.

These components can be made of any suitable material(s), including but not limited to stainless steel, AL6XN, Hastalloy, and titanium. It may be desirable that at least portions of the blade 16 and orifice component 5 to be made of materials with higher surface hardness or higher hardnesses. The components of the apparatus 100 can be made in any suitable manner, including but not limited to, by machining the same out of solid blocks of the materials described above. The components may be joined or held together in any suitable manner.

The various elements of the Apparatus A has described herein, are joined together. The term “joined”, as used in this specification, encompasses configurations in which an element is directly secured to another element by affixing the element directly to the other element; configurations in which the element is indirectly secured to the other element by affixing the element to intermediate member(s) which in turn are affixed to the other element; configurations where one element is held by another element; and configurations in which one element is integral with another element, i.e., one element is essentially part of the other element. In certain aspects, it may be desirable for at least some of the components described herein to be provided with threaded, clamped, or pressed connections for joining the same together. One or more of the components described herein can, for example, be clamped, held together by pins, or configured to fit within another component.

The Apparatus A comprises at least one inlet 1A, and typically comprises two or more inlets, such as inlets 1A and 1B, so that more than one material can be fed into the Apparatus A. The Apparatus A can comprise any suitable number of inlets so that any of such numbers of different materials can be fed into the Apparatus A. In another aspect, a pre-mix of two liquids can be introduced into just one inlet of the Apparatus A. This pre-mix is then subjected to shear, turbulence and/or cavitation as it is fed through the Apparatus A.

The Apparatus A may also comprise at least one drain, or at least one dual purpose, bidirectional flow conduit that serves as both an inlet and drain. The inlets and any drains may be disposed in any suitable orientation relative to the remainder of the Apparatus A. The inlets and any drains may, for example, be axially, radially, or tangentially oriented relative to the remainder of the Apparatus A. They may form any suitable angle relative the longitudinal axis of the Apparatus A. The inlets and any drains may be disposed on the sides of the apparatus. If the inlets and drains are disposed on the sides of the apparatus, they can be in any suitable orientation relative to the remainder of the apparatus.

In one aspect the Apparatus A comprises one inlet 1A in the form of an injector component that is axially oriented relative to the remainder of the apparatus. The injector component comprises an inlet for a first material.

The pre-mixing chamber 2 has an upstream end 3, a downstream end 4, and interior walls. In certain aspects, it may further be desirable for at least a portion of the pre-mixing chamber 2 to be provided with an initial axially symmetrical constriction zone 18 that is tapered (prior to the location of the downstream end of the injector) so that the size (e.g. diameter) of the upstream mixing chamber 2 becomes smaller toward the downstream end 4 of the pre-mixing chamber 2 as the orifice component 5 is approached.

The orifice component 5 can be in any suitable configuration. In some aspects, the orifice component 5 can comprise a single component. In other aspects, the orifice component 5 can comprise one or more components of an orifice component system. One aspect of an orifice component system 5 is shown in greater detail in FIG. 2.

The apparatus comprises an orifice component 5, wherein the orifice component comprises at least a first orifice unit 10 and a second orifice unit 11.

In the aspect shown in FIG. 2 the orifice component 5 comprises an orifice component housing 19. The first orifice unit 10 comprises a first orifice plate 12 comprising a first orifice 13 and a first orifice chamber 14. In one aspect, the first orifice unit 10 further comprises a first orifice bracket 15. The second orifice unit 11 also comprises a second orifice plate 20 comprising a second orifice 21, a second orifice chamber 23 and optionally a second orifice bracket 22. Looking at these components in greater detail, the orifice component housing 19 is a generally cylindrically-shaped component having side walls and an open upstream end 6, and a substantially closed (with the exception of the opening for the second orifice 21) downstream end 7.

Looking now at the first orifice unit 10, the orifice chamber 14 is located upstream from, and in liquid communication with, the orifice plate 12. The first orifice bracket 15 is sized and configured to fit inside the orifice component housing 9 adjacent to, and upstream of, the first orifice plate 12 to hold the first orifice plate 12 in place within the orifice component housing 9. The first orifice bracket 15 has interior walls which define a passageway through the first orifice chamber 14.

The second orifice unit 11 is substantially the same construction as the first orifice unit 10.

The orifice units 10 and 11 are arranged in series within the orifice component 5. Any number of orifice units can be arranged in series within the orifice component 5. Each orifice plate can comprise at least one orifice. The orifices can be arranged anywhere upon the orifice plate, providing they allow the flow of liquids through the Apparatus A. Each orifice plate can comprise at least one orifice arranged in a different orientation than the next orifice plate. In one aspect, each orifice plate comprises at least one orifice that is arranged so that it is off-centered as compared to the orifice in the neighbouring orifice plate. In one aspect, the size of the orifice within the orifice plate can be adjusted in situ to make it bigger or smaller, i.e. without changing or removing the orifice plate.

The first orifice bracket 15 and second orifice bracket 22, can be of any suitable shape or size, providing they secure the first orifice plates during operation of the Apparatus A. FIGS. 1 and 2 show an example of the orientation and size of an orifice bracket 22. In another aspect, the orifice bracket 22 may extend only half the distance between the second orifice plate 20 and the first orifice plate 12. In yet another aspect, the second orifice bracket 22 may extend only a quarter of the distance between the second orifice plate 20 and the first orifice plate 12.

In one aspect, the orifice plate 12 is hinged so that it can be turned 90° about its central axis. The central axis can be any central axis, providing it is perpendicular to the centre-line 27, which runs along the length of the Apparatus A. In one aspect, the central-axis can be along the axis line 28. By allowing the orifice 12 to be moved 90° about its central axis, build up of excess material in the first orifice chamber 14 and/or second orifice chamber 23 can be more readily removed. In one aspect, the size and/or orientation of the first orifice bracket 15 can be adjusted to allow the rotation of the first orifice plate 12. For example, in one aspect, the first orifice bracket 15 can be unsecured and moved in an upstream direction away from the first orifice plate 12 towards the pre-mixing chamber 2. The orifice plate 12 can then be unsecured and rotated through 90°. Once the Apparatus A is clean, the first orifice plate 12 can be returned to its original operating configuration and then if present, the first orifice bracket 15 returned to its original operating position. The second orifice plate 20 and also any extra orifice plates present, may also be hinged. The second orifice bracket 22 and any other orifice brackets present may also be adjustable in the manner as described for the first orifice bracket 15.

Any two orifice plates must be distinct from one another. In other words neighbouring orifice plates must not be touching. By “neighbouring”, we herein mean the next orifice plate in series. If two neighbouring plates are touching, mixing of liquids between orifices is not achievable. In one aspect, the distance between the first orifice plate 12 and the second orifice plate 20 is equal to or greater than 1 mm.

The elements of the orifice component 5 form a channel defined by walls having a substantially continuous inner surface. As a result, the orifice component 5 has few, if any, crevices between elements and may be easier to clean than prior devices. Any joints between adjacent elements can be highly machined by mechanical seam techniques, such as electro polishing or lapping such that liquids cannot enter the seams between such elements even under high pressures.

The orifice component 5, and the components thereof, can be made of any suitable material or materials. Suitable materials include, but are not limited to stainless steel, tool steel, titanium, cemented tungsten carbide, diamond (e.g., bulk diamond) (natural and synthetic), and coatings of any of the above materials, including but not limited to diamond-coated materials.

The orifice component 5, and the elements thereof, can be formed in any suitable manner. Any of the elements of the orifice component 5 can be formed from solid pieces of the materials described above which are available in bulk form. The elements may also be formed of a solid piece of one of the materials specified above, which may or may not be coated over at least a portion of its surface with one or more different materials specified above. Since the Apparatus A requires lower operating pressures than other shear, turbulence and/or cavitation devices, it is less prone to erosion of its internal elements due to mechanical and/or chemical wear at high pressures. This means that it may not require expensive coating, such as diamond-coating, of its internal elements.

In other aspects, the orifice component 5 with the first orifice 13 and the second orifice 21 therein can comprise a single component having any suitable configuration, such as the configuration of the orifice component shown in FIG. 2. Such a single component could be made of any suitable material including, but not limited to, stainless steel. In other aspects, two or more of the elements of the orifice component 5 described above could be formed as a single component.

The first orifice 13 and second orifice 21 are configured, either alone, or in combination with some other component, to mix the fluids and/or produce shear, turbulence and/or cavitation in the fluid(s), or the mixture of the fluids. The first orifice 13 and second orifice 21 can each be of any suitable configuration. Suitable configurations include, but are not limited to slot-shaped, eye-shaped, cat eye-shaped, elliptically-shaped, triangular, square, rectangular, in the shape of any other polygon, or circular.

The blade 16 has a front portion comprising a leading edge 29, and a rear portion comprising a trailing edge 30. The blade 16 also has an upper surface, a lower surface, and a thickness, measured between the upper and lower surfaces. In addition, the blade 16 has a pair of side edges and a width, measured between the side edges.

As shown in FIG. 1, when the blade 16 is inserted into the Apparatus A, a portion of the rear portion of the blade 16 is clamped, or otherwise joined inside the apparatus so that its position is fixed. The blade 16 can be configured in any suitable manner so that it can be joined to the inside of the apparatus.

As shown in FIG. 1, in some aspects, the Apparatus 16 may comprise a blade holder 17.

The Apparatus A comprises at least one outlet or discharge port 9.

The Apparatus A may comprise one or more extra inlets. These extra inlets can be positioned anywhere on the Apparatus A and may allow for the addition of extra liquids. In one aspect, the second orifice unit comprises an extra inlet. In another aspect, the secondary mixing chamber comprises an extra inlet. This allows for the addition of an extra liquid to be added to liquids that have exited the orifice component 5.

It is also desirable that the interior of the Apparatus A be substantially free of any crevices, nooks, and crannies so that the Apparatus A will be more easily cleanable between uses. In one aspect of the Apparatus A described herein, the orifice component 5 comprises several elements that are formed into an integral structure. This integral orifice component 5 structure fits as a unit into the pre-mixing chamber housing and requires no backing block to retain the same in place, eliminating such crevices.

Numerous other aspects of the Apparatus A and components therefore are possible as well. The blade holder 17 could be configured to hold more than one blade 16. For example, the blade holder 17 could be configured to hold two or more blades.

Apparatus B

Applicants have found it is desirable to subject said fluid from said outlet 9 of Apparatus A, to additional shear and/or turbulence for a period of time within Apparatus B to transform said liquid into a desired microstructure. Shear or turbulence imparted to said fluid may be quantified by estimating the total kinetic energy per unit fluid volume. The total kinetic energy imparted to the fluid is the sum total of the kinetic energy per unit fluid volume times the residence time as said fluid flows through each of the conduits, pumps, and in-line shearing or turbulence devices that the fluid experiences.)

In one aspect, Apparatus B may comprise one or more inlets for the addition of adjunct ingredients.

In one aspect of Apparatus B, one or more Circulation Loop Systems are in fluid communication to said outlet 9 of Apparatus A. Said Circulation Loop systems may be arranged in series or in parallel. Said fluid from outlet 9 of Apparatus A is fed to one or more Circulation Loop Systems, composed of one or more fluid inlets, connected to one or more circulation system pumps, one or more circulation loop conduits of a specified cross sectional areas and lengths, one or more connections from said circulating loop conduits to said inlet of one or more circulation pumps, and one or more fluid outlets, connected to said circulation loop system conduits. It is recognized that one or more conduits may be necessary to achieve the desired residence time. One or more bends or elbows in said conduits may be useful to minimize floor space.

An example of said Circulation Loop Systems is shown if FIG. 3. Said fluid from Apparatus A outlet 9 is fed to a single Circulation Loop System comprising a fluid inlet, 50, in fluid communication with a circulation loop system pump, 51, in fluid communication with a circulation system loop conduit of a specified cross sectional area and length, 52, in fluid communication with a fluid connection, 53, from said circulating loop conduit 52 to said inlet of said circulation pump 51, and a fluid outlet, 54, in fluid communication with said circulation loop conduit, 52. In said aspect, said fluid inlet flow rate is equal to the fluid outlet flow rate. Said Circulation Loop System has a Circulation Loop Flow Rate equal to or greater than said inlet or outlet flow rate into or out of said Circulation Loop System. The Circulating Loop System may be characterized by a Circulation Flow Rate Ratio equal to the Circulation Flow Rate divided by the Inlet or Outlet Flow Rate.

Said Circulation Loop System example has one or more conduit lengths and diameters and pumps arranged in a manner that imparts shear or turbulence to the fluid. The circulation loop conduits may be in fluid communication with one or more devices to impart shear or turbulence to said fluid including but not limited to static mixers, orifices, flow restricting valves, and/or in-line motor driven milling devices as those supplied by IKA, Staufen and devices known in the art. It is recognized that one or more bends or elbows in said conduits may be useful to deliver the desired kinetic energy and residence time while minimizing floor space. The duration of time said fluid spends in said Circulation Loop System example may be quantified by a Residence Time equal to the total volume of said Circulation Loop System divided by said fluid inlet or outlet flow rate.

In another aspect, Apparatus B may be comprised of one or more continuously operated tanks arranged either in series or in parallel. The fluid from Apparatus A outlet 9 is in fluid communication and continuously fed to an tank of suitable volume and geometry. In a example, said fluid enters and leaves said tank at identical flow rates. The residence time of said fluid in said tanks is equal to the volume of fluid in said tanks divided by the inlet or outlet flow rates. Said tanks may be fitted with one or more agitation devices such as mixers consisting of one or more impellers attached to one or more shafts that are driven by one or more motors. The agitation device maybe also be one or more tank milling devices such as those supplied by IKA, Staufen, Germany, including batch jet mixers and rotor-stator mills. The tank may be fitted with one or more baffles to enhance mixing shear or turbulence within the tank. The tank may consist of a means to control the fluid temperature within the tank using but not limited to internal coils or a wall jacket containing a circulating cooling or heating fluid.

The tank may also have an external circulation system that provides additional kinetic energy per unit fluid volume and residence time. Said external circulating system may consist but is not limited to one or more tank outlet conduits, one or more motor driven fluid pumps, one or more static shearing devices, one or more motor driven shearing mills, one or more inlet circulation conduits returning the fluid back to the tank all in fluid communication and may be arranged in series or parallel.

In another aspect of Apparatus B, one or more of said tanks may be filled with fluid and held in the tank with mixing and or circulation as described above to impart kinetic energy per unit fluid volume for a desired residence time and then removed from an outlet from the tank.

In another aspect of Apparatus B, one or more conduits may be used to impart shear or turbulence to a fluid for a desired residence time. The conduit may be in fluid communication with but not limited to one or more motor driven fluid pumps, one or more static shearing devices, one or more motor driven shearing mills, arranged in any order in series or parallel. It is recognized that one or more long conduits may be necessary to achieve the desired residence time. One or move bends or elbows in said conduits may be useful to minimize floor space.

During said shearing and turbulence within Apparatus B, one or more optional adjunct fluids may be added to said fluids to help create the desired fluid microstructure. Addition of said optional adjunct fluids to said fluid may be accomplished by means known to those in the fluid processing industry and added anywhere in Apparatus B. Not bound by theory, one or more optional adjunct fluids may be added at a point in Apparatus B that insures uniform dispersion and mixing of said optional adjunct fluid with said fluid. In one aspect in the Continuous Loop System example above, said optional adjunct fluids may be introduced at an inlet, 55, by means of a pump, 56, to an injector, 57, in fluid communication with the continuous loop pump, 51, inlet. Additionally, said optional adjunct fluid also may also be added at, but not limited to, said continuous loop inlet, 50, and or in said circulation loop conduit, 52, and or simultaneously in any combination of addition points.

During shearing in Apparatus B, the temperature of said fluid may be controlled or changed depending on the transformation requirements. In one aspect, it may be useful to alter said fluid temperature within Apparatus B. Said fluid temperature change may be accomplished by means known to those in the fluid processing industry and may include but are not limited to heat exchangers, pipe jackets, and injection of one or more additional hotter or colder optional adjunct fluids into said fluid.

In one aspect, the fluid communication between the outlet of Apparatus A and the inlet of Apparatus B, may be limited to a fluid residence time of less than about 10 minutes, less than about 1 minute, less than about 20 seconds, less than about 10 seconds, less than about 5 seconds, or less than about 3 seconds depending on the transformations required. In another aspect, the fluid communication between the outlet of Apparatus A and the inlet of Apparatus B, may be limited to a fluid residence time of from about 0.01 seconds to about 10 minutes.

Said fluid inlets and outlets of said Apparatus B may be in fluid communication with one or more other devices. These devices include but are not limited to a means of regulating the temperature of said fluid including but not limited to heat exchangers, means of regulating Apparatus B pressure including but not limited to pressure control valves and booster pumps, means of removing contaminants from said fluid including but not limited to filtration devices, means of adding one or more adjunct ingredients to said fluid from but not limited to adjunct ingredient delivery systems, means of monitoring process control features including but not limited to flow, pressure and temperature gauges and transmitters, sampling valves and means of cleaning and sanitization.

Applicants believe, although not bound by theory, that Apparatus B should be designed to impart a uniformly consistent kinetic energy over a period of time to each fluid volume element to ensure uniformity of the desired fluid microstructure attributes.

In one aspect, the device used to manufacture the fabric enhancer of the present invention is an ultrasonic mixer. One non-limiting example of a commercially available device for use herein, includes the ultrasonic homogenizer is the Sonolator™, supplied by Sonic Corporation of Connecticut.

Method of Use

The compositions of the present invention may be used to treat fabric by administering a dose to a laundry washing machine or directly to fabric (e.g., spray). Such method comprises contacting the fabric with a composition described in the present specification. The compositions may be administered to a laundry washing machine during the rinse cycle or at the beginning of the wash cycle, typically during the rinse cycle. The fabric care compositions of the present invention may be used for handwashing as well as for soaking and/or pretreating fabrics. The composition may be in the form of a powder/granule, a bar, a pastille, foam, flakes, a liquid, a dispersible substrate, or as a coating on a dryer added fabric softener sheet. The composition may be administered to the washing machine as a unit dose or dispensed from a container (e.g., dispensing cap) containing multiple doses. An example of a unit dose is a composition encased in a water soluble polyvinylalcohol film.

In one aspect, a method of treating and/or cleaning a situs, said method comprising
a) optionally washing and/or rinsing said situs;
b) contacting said situs with a liquid fabric enhancer composition disclosed herein; and
c) optionally washing and/or rinsing said situs.
d) optionally drying said situs via and automatic dryer and/or line drying
is disclosed.

### TEST METHODS

Methods for assessing (i) silicone deposition, (ii) stringiness, (iii) viscosity of the compositions disclosed herein are detailed below.

Assessing Silicone Deposition on Fabric. Fabrics are treated with a liquid fabric softener of the preset invention that containing (17.5% bis-(2-hydroxyethyl)-dimethylammonium chloride fatty acid ester, 1% polydimethylsiloxane, and 0.1% of the respective polymer (i.e., Examples 1-3)—all by weight of the liquid fabric softener composition) during the rinse cycle. After completion of the rinse, fabrics are dried in dryers, the fabric is cut into swatches are and analyzed for the amount of silicone deposited per gram of fabric. The extraction solvent is selected. For non-polar silicones, the extraction solvent is toluene/Methyl isobutyl ketone (50%//50%). For polar silicones, the extraction is Methyl isobutyl ketone/methanol/AE3S (84.45%/15.5%/0.05%). The amount of silicone deposited is determined by the ICP/MS.

Assessing Stringiness of the Fabric Care Product. Cationic deposition aid polymers are dissolved in water and added to liquid fabric softener that containing

(15.3% bis-(2-hydroxyethyl)-dimethylammonium chloride fatty acid ester, and 0.2% of the respective polymer (i.e., Examples 1-3)—all by weight of the liquid fabric softener composition). Each mixture is brought to a pH of approximately 3.5 with 1.0N HCl. Stringiness is measured using the Capillary Breakup Extensional Rheometer (Thermo Fisher Scientific HAAKE CaBER™ 1). The instrument settings are adjusted as in the below table using the required software supplied by the manufacturer. After the sample is loaded and the measurement initiated, the data is collected automatically as described in the detailed HAAKE CaBER 1 Operating Manual supplied with the instrument or available on the online manufacturer's website. The data is the critical time to breakup (expressed in seconds).

Setting Specifications Used on the Thermo Fisher Scientific HAAKE CaBER™ 1:

| Hencky strain: | 1.84 | |
|---|---|---|
| Shear Viscosity range: | 10-10⁶ | mPas |
| Plate/Sample diameter: | Standard = 6 mm | |
| Temperature range: | Ambient | |
| Diameter resolution: | 0.1 | nmm |
| System response time: | 10 | ms |
| Drive system used: | Linear drive | |
| Sample start height: | 0.996 | mm |
| Sample end height: | 6.29 | mm |

| | |
|---|---|
| Sample data collection time: | 0 s-6 s |
| Replicates averaged for one sample result | 5 |

Assessing Viscosity: Viscosity is measured using a Brookfield DV-E viscometer fitted with a LV2 spindle at 60 RPM. The test is conducted in accordance with the instrument's instructions.

### EXAMPLES

The following are non-limiting examples of the compositions of the present invention such compositions are made by one or more of the processes of making disclosed in the present specification.

| (% wt) | I | II | III | IV | V |
|---|---|---|---|---|---|
| FSA ^{a} | 12 | 21 | 18 | 14 | 12 |
| FSA ^{b} | — | — | — | — | — |
| FSA ^{c} | — | — | — | — | — |
| Low MW alcohol | 1.95 | 3.0 | 3.0 | 2.28 | 2.28 |
| Rheology modifier^{d,e,} | 1.25^{d} | — | 0.2^{e} | — | 0.2^{e} |
| Perfume | 1.50 | 2.3 | 2.0 | 1.50 | 1.50 |
| Perfume encapsulation | 0.6 | 0.3 | 0.4 | — | 0.15 |
| Phase Stabilizing Polymer ^{f} | 0.25 | — | — | 0.142 | 0.25 |
| Suds Suppressor ^{g} | — | — | — | — | — |
| Calcium Chloride | 0.10 | 0.12 | 0.1 | 0.45 | 0.55 |
| DTPA ^{h} | 0.005 | 0.005 | 0.005 | 0.005 | 0.005 |
| Preservative (ppm) i | 5 | 5 | 5 | 5 | 5 |
| Antifoam ^{j} | 0.015 | 0.15 | 0.11 | 0.011 | 0.011 |
| Polyethylene imines ^{l} | 0.15 | 0.05 | — | 0.1 | — |
| Hydrophobically modified | 0.23 | 0.1 | 0.2 | 0.15 | 1.0 |
| cationic polymer ^{m} | | | | | |
| PDMS emulsion ⁿ | — | 0.5 | 1 | 2.0 | — |
| Stabilizing Surfactant ^{o} | — | — | 0.5 | 0.2 | 0.2 |
| Organosiloxane polymer ^{p} | 5 | — | — | — | — |
| Amino-functional silicone | — | — | — | — | 5 |
| Dye (ppm) | 40 | 11 | 30 | 40 | 40 |
| Ammonium Chloride | 0.10 | 0.12 | 0.12 | 0.10 | 0.10 |
| HCl | 0.010 | 0.01 | 0.10 | 0.010 | 0.010 |
| Deionized Water | Balance | Balance | Balance | Balance | Balance |

| (% wt) | VI | VII | VIII | IX | X | XI | XII |
|---|---|---|---|---|---|---|---|
| FSA ^{a} | 16 | 12 | 5 | 5 | — | — | — |
| FSA ^{b} | — | — | — | — | 3.00 | — | — |
| FSA ^{c} | — | — | — | — | — | 7 | — |
| FSA ^{z} | — | — | — | — | — | — | 12 |
| Low MW alcohol | 1.50 | 2.68 | 0.81 | 0.81 | 0.3 | 0.9 | — |
| Rheology modifier^{d,e,} | — | — | 0.42^{d} | 0.25^{e} | 0.5^{d} | 0.70^{d} | — |
| Perfume | 2.20 | 1.50 | 0.60 | 0.60 | 1.30 | 0.8-1.5 | 2.4 |
| Perfume encapsulation | 0.4 | 0.25 | — | 0.3 | 0.1 | — | — |
| Phase Stabilizing Polymer ^{f} | — | 0.25 | — | — | — | — | — |
| Suds Suppressor ^{g} | — | — | 0.1 | — | — | 0.1 | — |
| Calcium Chloride | 0.350 | 0.545 | — | — | — | 0.1-0.15 | 0.05 |
| DTPA ^{h} | 0.005 | 0.007 | 0.002 | 0.002 | 0.20 | — | 0.05 |
| Preservative (ppm) i | 5 | 5 | 5 | 5 | — | 250 | 75 |
| Antifoam ^{j} | 0.011 | 0.011 | 0.015 | 0.015 | — | — | 0.005 |
| Polyethylene imines ^{l} | — | 0.1 | — | 0.05 | — | — | — |
| Hydrophobically modified | 0.5 | 0.23 | 0.4 | 0.1 | 0.15 | 0.1-0.2 | 0.1 |
| cationic polymer ^{m} | | | | | | | |
| PDMS emulsion ⁿ | — | — | 0.25 | — | — | — | — |
| Stabilizing Surfactant ^{o} | 0.1 | 0.2 | — | — | — | — | — |
| Organosiloxane polymer ^{p} | 2 | — | — | — | — | 0-5.0 | 3.0 |
| Amino-functional silicone | — | 2 | — | — | — | 0-5.0 | — |
| Dye (ppm) | 40 | 40 | 30 | 30 | 11 | 30-300 | 30-300 |
| Ammonium Chloride | 0.10 | 0.115 | — | — | — | — | — |
| HCl | 0.010 | 0.010 | 0.011 | 0.011 | 0.016 | 0.025 | 0.01 |
| Deionized Water | Balance | Balance | Balance | Balance | Balance | Balance | Balance |

^{a} N,N-di(tallowoyloxyethyl)-N,N-dimethylammonium chloride.
^{b} Methyl bis(tallow amidoethyl)2-hydroxyethyl ammonium methyl sulfate.
^{c} Reaction product of Fatty acid with Methyldiethanolamine in a molar ratio 1.5:1, quaternized with Methylchloride, resulting in a 1:1 molar mixture of N,N-bis(stearoyl-oxy-ethyl) N,N-dimethyl ammonium chloride and N-(stearoyl-oxy-ethyl) N,-hydroxyethyl N,N dimethyl ammonium chloride.
^{z} The Reaction product of fatty acid with an iodine value of 40 with methyl/diisopropylamine in a molar ratio from about 1.86 to 2.1 fatty acid to amine and quaternized with methyl sulfate.
^{d}Cationic high amylose maize starch available from National Starch under the trade name HYLON VII ®.
^{e}Cationic polymer available from Ciba under the name Rheovis CDE.
^{f} Copolymer of ethylene oxide and terephthalate having the formula described in U.S. Pat. No. 5,574,179 at col. 15, lines 1-5, wherein each X is methyl, each n is 40, u is 4, each R1 is essentially 1,4-phenylene moieties, each R2 is essentially ethylene, 1,2-propylene moieties, or mixtures thereof.
^{g} SE39 from Wacker.
^{h} Diethylenetriaminepentaacetic acid.
i Koralone B-119 available from Rohm and Haas Co. “PPM” is “parts per million.”
^{j} Silicone antifoam agent available from Dow Corning Corp. under the trade name DC2310.
^{l} Polyethylene imines available from BASF under the trade name Lupasol.
^{m} Hydrophobically modified cationic polymers as disclosed in present specification including not limited to.

1. polyethylene imines modified dodecene oxide selected from
   i. PEI (Mw 25 000)+0.2 C₁₂O/NH
   ii. PEI (Mw 25 000)+0.5 C₁₂O/NH
   iii. PEI (Mw 25 000)+0.7 C₁₂O/NH
2. polyethylene imines modified with an inner Ethylene Oxide block and an outer dodecene oxide block:
   i. PEI (Mw 600)+0.8 EO/NH+0.2 C₁₂O/NH
   ii. PEI (Mw 5000)+0.8 EO/NH+0.2 C₁₂O/NH
   iii. PEI (Mw 25 000)+0.8 EO/NH+0.2 C₁₂O/NH
3. Polyvinyl amines modified with polyisobutylene succinic anhydride
   II. Polyvinylamine (Mw 15000)-polyisobutene1000-succinicanhydride (83:17 w/w)
   III. Polyvinylamine (Mw 45000)-polyisobutene1000-succinicanhydride (91:9 w/w)
   IV. Polyvinylamine (Mw 360000)-polyisobutene1000-succinicanhydride (98:2 w/w)
   V. Polyvinylamine (Mw 360000)-polyisobutene1000-succinicanhydride (99:1 w/w)
4. Hydrophobically cationic polymer containing formula (1) and (II)

### Example XIII

The fluid fabric enhancer active formulations in Examples I-XII are used to soften fabrics. The formulations are used in a laundry rinse of an automatic laundry washing machine. Upon completion of the rinse, the fabrics are either machine dried or line dried.

### Example XIV

Each of the fluid fabric enhancer active formulations of Examples I-XII are also placed in a unit dose packaging comprising a film that surrounds each formulations. Such unit does are used by adding the unit dose to the wash liquor and/or the rinse. Upon completion of the rinse, the fabrics are either machine dried or line dried.

### Example XV

### Methods of Preparation of Hydrophobically Modified Cationic Polymer Emulsion Polymerization

An aqueous phase of water-soluble components is prepared by mixing the following components:

1.88 g (0.5 pphm) of citric acid 1-hydrate,
109.85 g (29.32 pphm) of water,
1.07 g (0.29 pphm) of pentasodium diethylenetriaminepentaacetic acid,
500.00 g (100 pphm) of 2-trimethylammoniumethyl methacrylate chloride (quaternized dimethylaminoethyl methacrylate) (TMAEMC 75% in water).

An oil phase is prepared by mixing the following components:

12.24 g (2.45 pphm) of sorbitan trioleate (75% in dearomatized aliphatic hydrocarbon [Exxsol D40]),
103.83 g (5.22 pphm) of a polymeric stabilizer: stearyl methacrylate-methacrylic acid copolymer (19% in dearomatized aliphatic hydrocarbon [Exxsol D40]),
231.57 g (61.75 pphm) of 2-ethylhexyl stearate (Crodamol OS), and
92.10 g (24.56 pphm) of dearomatized aliphatic hydrocarbon [Exxsol D40].
(0.19 pphm) of C 16EO25Mac associative monomer (Plex 6954 O)

The two phases are mixed in a ratio of 58.2 parts of aqueous phase to 41.8 parts of oil phase with high shear to produce a water-in-oil emulsion. The water-in-oil emulsion which forms is introduced into a reactor equipped with nitrogen spray line, stirrer and thermometer. The emulsion is purged with nitrogen, which removes the oxygen.

The polymerization is achieved by adding a redox pair consisting of

13 g (0.05 pphm) of sodium metabisulfite (1% in demineralized water) and
13 g (0.05 pphm) of tert-butyl hydroperoxide (1% in demineralized water).

The rate for the addition of the redox pair is 13 g in 2 hours, the temperature being kept constant at 50° C. Thereafter, a free radical initiator (2,2′-azobis(2-methylbutyronitrile), CAS: 13472-08-7) is added in two steps (the 2nd step after 45 min) and the emulsion is kept at 85° C. for 75 minutes.

By means of vacuum distillation, water and low-boiling constituents of the oil phase (Exxsol D40) are removed.

2-ethylhexyl stearate (Crodamol OS) is added to the vacuum-distilled product to achieve a solids content of 53.5%.

Thereafter, 7% (based on the total proportion by mass of this product) of a fatty alcohol alkoxylate [alcohol C6-C17(secondary) poly(3-6)ethoxylate: 97% secondary alcohol ethoxylate+3% poly(ethylene oxide)], known as Tergitol™ 15-S-7 (CAS No. 84133-50-6), is added to prepare a thickener (dispersion) with polymer solids content 50%. The ratio of activator to cationic polymer is thus 14.0:100 [% by weight/% by weight].

The associative monomer C16EO25MAc is introduced into the oil phase. The commercial product Plex 6954 O is used, which comprises 60% by weight of associative monomer and, as solvents, water and MAA in a ratio of approx. 1:1. The weight data in Table 2 are based on the amount of associative monomer without solvent. The ratio of activator to cationic polymer is 14.0:100 [% by weight/% by weight]; unless stated otherwise, the particular polymer (dispersion) have polymer solids content 50%.

TABLE x

| | C16EO25MAc | TMAEMC | | | | |
|---|---|---|---|---|---|---|
| Examples | (pphm) | (pphm) | MBA | TAAC | NaHP | Comment |
| 1.1 | 0.19 | 99.75 | — | — | — | |
| 1.2 | 0.19 | 99.75 | — | — | — | polymer solids content 30%; |
| | | | | | | amount of activator adjusted |
| | | | | | | correspondingly |
| 1.3 | 0.19 | 99.75 | — | — | — | Temperature regime as 85 C., |
| | | | | | | but +1° C./min |
| 1.4 | 0.19 | 99.75 | — | — | 0.16 | |
| 1.5 | 0.19 | 99.75 | 0.06 | 0.02 | 0.05 | |
| 1.6 | 0.19 | 99.75 | — | — | — | |
| 1.7 | 0.38 | 74.50 | | | | 25 pphm of acrylamide |
| 1.9 | 0.76 | 99.00 | | | | |
| 1.10 | 0.38 | 49.5 | | | | 50 pphm of acrylamide |

Preparation of Polyvinylamine Modified with Polyisobutylene Succinic Anhydride

Polyolefin-substituted succinic anhydrides like polyisobutylene succinic anhydrides are obtained from an alkene and an appropriate amount of a succinic anhydride precursor, i.e. maleic anhydride. DE4319672 describes a process for the preparation of polyisobutylene succinic anhydride.

WO9850630 describes polyvinylamines, modified with reactive hydrophobic components like polyisobutylene succinic anhydride.

The reaction products of polyisobutylene succinic anhydride and polyvinylamines may be prepared by heating them together, suitably at temperatures from 10° C. to 100° C., or between 40° C. to 70° C.

The molar ratio of polyisobutylene succinic anhydride to polyvinylamines may vary within a wide range from 0.001 to 1.0 mole anhydride per mole of NH₂ moiety.

The reaction is carried out in substance, in water or in water together with an organic solvent. Suitable organic solvents are in particular nonpolar and polar aprotic organic solvents. Examples of particularly suitable nonpolar aprotic solvents include aliphatic and aromatic hydrocarbons such as hexane, cyclohexane, toluene and xylene. Examples of particularly suitable polar aprotic solvents are ethers, in particular cyclic ethers such as tetrahydrofuran and dioxane, N,N-dialkylamides such as dimethylformamide and dimethylacetamide, and N-alkyllactams such as N-methylpyrrolidone. It is of course also possible to use mixtures of these organic solvents. Preferred organic solvents are xylene and toluene. Using xylene or toluene in combination with water, water is removed from the reaction mixture by azeotropic distillation. Subsequent the reaction, the organic solvent is typically removed. The products may be isolated in substance.

### Alkoxylation of Polyalkylene Imines

The alkoxylated polyalkylenimines may be prepared in a known manner by reaction of polyalkylene imines with alkylene oxides. Suitable alkylene oxides are C₂-C₂₀ alkylene oxides like ethylene oxide, propylene oxide, butylene oxide, pentene oxide, hexene oxide, decene oxide, dodecene oxide etc. Polyalkylene imines are reacted with one single alkylene oxide or combinations of two or more different alkylene oxides. Using two or more different alkylene oxides, the resulting polymer an be obtained as a block-wise structure or a random structure. One preferred procedure consists in initially undertaking only an incipient alkoxylation of the polyalkylene imine in a first step. In this step, the polyalkylene imine is reacted only with a portion of the total amount of alkylene oxide used, which corresponds to about 1 mol of alkylene oxide per mole of NH moiety. This reaction is undertaken generally in the absence of a catalyst in an aqueous solution at a reaction temperature from about 70 to about 200° C. or from about 80 to about 160° C. This reaction may be affected at a pressure of up to about 10 bar, and in particular up to about 8 bar.

In a second step, the further alkoxylation is then effected by subsequent reaction with the remaining amount of alkylene oxide. The further alkoxylation is undertaken typically in the presence of a basic catalyst. Examples of suitable catalysts are alkali metal and alkaline earth metal hydroxides such as sodium hydroxide, potassium hydroxide and calcium hydroxide, alkali metal alkoxides, in particular sodium and potassium C₁-C₄-alkoxides, such as sodium methoxide, sodium ethoxide and potassium tert-butoxide, alkali metal and alkaline earth metal hydrides such as sodium hydride and calcium hydride, and alkali metal carbonates such as sodium carbonate and potassium carbonate. Preference is given to the alkali metal hydroxides and the alkali metal alkoxides, particular preference being given to potassium hydroxide and sodium hydroxide. Typical use amounts for the base are from 0.05 to 10% by weight, in particular from 0.5 to 2% by weight, based on the total amount of polyalkyleneimine and alkylene oxide.

The further alkoxylation may be undertaken in substance (variant a)) or in an organic solvent (variant b)). In variant a), the aqueous solution of the incipiently alkoxylated polyalkylenimine obtained in the first step, after addition of the catalyst, is initially dewatered. This can be done in a simple manner by heating to from about 80 to about 150° C. and distilling off the water under a reduced pressure of from about 0.01 to about 0.5 bar. The subsequent reaction with the alkylene oxide is effected typically at a reaction temperature from about 70 to about 200° C. or from about 100 to about 180° C. The subsequent reaction with the alkylene oxide is effected typically at a pressure of up to about 10 bar and in particular up to 8 bar. The reaction time of the subsequent reaction with the alkylene oxide is generally about 0.5 to about 4 hours.

Suitable organic solvents for variant b) are in particular nonpolar and polar aprotic organic solvents. Examples of particularly suitable nonpolar aprotic solvents include aliphatic and aromatic hydrocarbons such as hexane, cyclohexane, toluene and xylene. Examples of particularly suitable polar aprotic solvents are ethers, in particular cyclic ethers such as tetrahydrofuran and dioxane, N,N-dialkylamides such as dimethylformamide and dimethylacetamide, and N-alkyllactams such as N-methylpyrrolidone. It is of course also possible to use mixtures of these organic solvents. Preferred organic solvents are xylene and toluene.

In variant b), the solution obtained in the first step, after addition of catalyst and solvent, is initially dewatered, which is advantageously done by separating out the water at a temperature of from about 120 to about 180° C., in one aspect, supported by a gentle nitrogen stream. The subsequent reaction with the alkylene oxide may be effected as in variant a). In variant a), the alkoxylated polyalkylenimine is obtained directly in substance and may be converted if desired to an aqueous solution. In variant b), the organic solvent is typically removed and replaced by water. The products may, of course, also be isolated in substance.

Polyalkylene Imines Modified with Polyisobutylene Succinic Anhydride

Polyolefin-substituted succinic anhydrides like polyisobutylene succinic anhydrides are obtained from an alkene and an appropriate amount of a succinic anhydride precursor, i.e. maleic anhydride. DE4319672 describes a process for the preparation of polyisobutylene succinic anhydride.

Reaction products from polyisobutylene succinic anhydride with polyamines are described in WO9842808, EP271937 etc.

The reaction products of polyisobutylene succinic anhydride and polyalkylene imines may be prepared by heating them together, suitably at temperatures of at least 80° C., e.g. from 100° C. to 300° C., or between 120° C. to 250° C. The molar ratio of polyisobutylene succinic anhydride to polyalkylene imine may vary within a wide range from 0.001 to 1.0 mole anhydride per mole of NH moiety. The reaction is carried out in substance or in an organic solvent. Suitable organic solvents are in particular nonpolar and polar aprotic organic solvents. Examples of particularly suitable nonpolar aprotic solvents include aliphatic and aromatic hydrocarbons such as hexane, cyclohexane, toluene and xylene. Examples of particularly suitable polar aprotic solvents are ethers, in particular cyclic ethers such as tetrahydrofuran and dioxane, N,N-dialkylamides such as dimethylformamide and dimethylacetamide, and N-alkyllactams such as N-methylpyrrolidone. It is of course also possible to use mixtures of these organic solvents. Preferred organic solvents are xylene and toluene.

Subsequent the reaction, the organic solvent is typically removed and replaced by water. The products may, of course, also be isolated in substance.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition comprising, based on total composition weight,
a) at least 0.01% of a hydrophobically modified cationic polymer wherein said hydrophobically modified cationic polymer has the formula PS wherein P is selected from the group consisting a polyamine, a polyacrylamide, a polyacrylate, a polyvinylpyrrolidone and mixtures thereof and S is at least one hydrophobic moiety and the ratio of monomeric units in P to S is no greater than 10:1 with the provisos that P comprises at least 10 monmeric units, that said hydrophobically modified cationic polymer comprises at least one S and that the value for S is always truncated to an integer; and
b) a fabric softener active,
said composition having a viscosity of less than 2000 cps.

2. The composition of claim 1 wherein said fabric softener active is selected from the group consisting of di-tail fabric softener actives, mono-tail fabric softener actives, ion pair fabric softener actives and mixtures thereof.

3. The composition of claim 2 wherein said di-tail fabric softener active, mono-tail fabric softener active and ion pair fabric softener actives are selected from the group consisting of:
a) materials having Formula (1) below 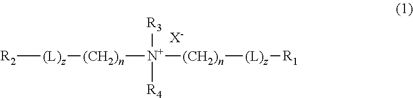
wherein:
(i) R₁ and R₂ are each independently a C₅-C₂₃ hydrocarbon;
(ii) R₃ and R₄ are each independently selected from the group consisting of C₁-C₄ hydrocarbon, C₁-C₄ hydroxy substituted hydrocarbon, benzyl, —(C₂H₄O)_{y}H where y is an integer from 1 to 10;
(iii) L is selected from the group consisting of —C(O)O—, —(OCH₂CH₂)ₘ—, —(CH₂CH₂O)ₘ—, —C(O)—, —O—(O)C—, —NR—C(O)—, —C(O)—NR— wherein m is 1 or 2 and R is hydrogen or methyl;
(iv) each n is independently an integer from 0 to 4 with the proviso that when L is —C(O)O—, —O—(O)C—, —NR—C(O)—, or —C(O)—NR— the respective n is an integer from 1 to 4;
(v) each z is independently 0 or 1; and
(vi) X⁻ is a softener-compatible anion;
b) materials having Formula (2) below 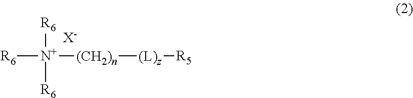
wherein
(i) R₅ is a C₅-C₂₃ hydrocarbon;
(ii) each R₆ is independently selected from the group consisting of C₁-C₄ hydrocarbon, C₁-C₄ hydroxy substituted hydrocarbon, benzyl, —(C₂H₄O)_{y}H where y is an integer from 1 to 10;
(iii) L is selected from the group consisting of —C(O)O—, —(OCH₂CH₂)ₘ—(CH₂CH₂O)ₘ—, —C(O)—, —O—(O)C—, —NR—C(O)—, —C(O)—NR— wherein m is 1 or 2 and R is hydrogen or methyl;
(iv) each n is independently an integer from 0 to 4 with the proviso that when L is —C(O)O—, —O—(O)C—, —NR—C(O)—, or —C(O)—NR— the respective n is an integer from 1 to 4;
(v) z is 0 or 1; and
(vi) X⁻ is a softener-compatible anion;
c) materials having Formula (3) below 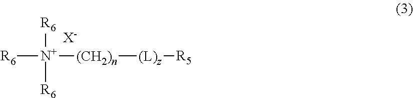
wherein
(i) R₅ is a C₅-C₂₃ hydrocarbon;
(ii) each R₆ is independently selected from the group consisting of C₁-C₄ hydrocarbon, C₁-C₄ hydroxy substituted hydrocarbon, benzyl, —(C₂H₄O)_{y}H where y is an integer from 1 to 10;
(iii) L is selected from the group consisting of —C(O)O—, —(OCH₂CH₂)ₘ—(CH₂CH₂O)ₘ—, —C(O)—, —O—(O)C—, —NR—C(O)—, —C(O)—NR— wherein m is 1 or 2 and R is hydrogen or methyl;
(iv) each n is independently an integer from 0 to 4 with the proviso that when L is —C(O)O—, —O—(O)C—, —NR—C(O)—, or —C(O)—NR— the respective n is an integer from 1 to 4;
(v) z is 0 or 1; and
(vi) X⁻ is an anionic surfactant comprising a C₆-C₂₄ hydrocarbon.

4. The composition of claim 3 wherein said di-tail fabric softener active, mono-tail fabric softener active and ion pair fabric softener actives are selected from the group consisting of:
a) materials having Formula (1) below 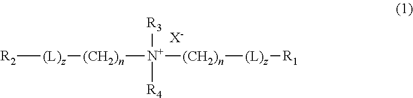
wherein:
(i) R₁ and R₂ are each independently a C₁₁-C₁₇ hydrocarbon;
(ii) R₃ and R₄ are each independently selected from the group consisting of C₁-C₂ hydrocarbon, C₁-C₂ hydroxy substituted hydrocarbon;
(iii) each n is independently an integer from 1 to 2;
(iv) L is selected from the group consisting of —C(O)O—, —C(O)—, —O—(O)C—;
(v) each z is independently 0 or 1; and
(vi) X— is a softener-compatible anion, selected from the group consisting of halides, sulfonates, sulfates, and nitrates
b) materials having Formula (2) below 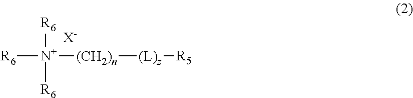
wherein
(i) R₅ is a C₁₁-C₁₇ hydrocarbon;
(ii) each R₆ is independently selected from the group consisting of C₁-C₂ hydrocarbon, C₁-C₂ hydroxy substituted hydrocarbon;
(iii) n is an integer from 1 to 4;
(iv) L is selected from the group consisting of —C(O)O—, —C(O)—, —O—(O)C—;
(v) z is 0 or 1; and
(vi) X⁻ is a softener-compatible anion, selected from the group consisting of halides, sulfonates, sulfates, and nitrates;
c) materials having Formula (3) below 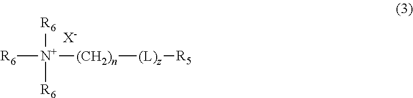
wherein
(i) R₅ is a C₅-C₂₃ hydrocarbon;
(ii) each R₆ is independently selected from the group consisting of C₁-C₄ hydrocarbon, C₁-C₄ hydroxy substituted hydrocarbon, benzyl, —(C₂H₄O)_{y}H where y is an integer from 1 to 10;
(iii) L is selected from the group consisting of —C(O)O—, —(OCH₂CH₂)ₘ—(CH₂CH₂O)ₘ—, —C(O)—, —O—(O)C—, —NR—C(O)—, —C(O)—NR— wherein m is 1 or 2 and R is hydrogen or methyl;
(iv) each n is independently an integer from 0 to 4 with the proviso that when L is —C(O)O—, —O—(O)C—, —NR—C(O)—, or —C(O)—NR— the respective n is an integer from 1 to 4;
(v) z is 0 or 1; and
(vi) X— is an anionic surfactant comprising a C₆-C₂₄ hydrocarbon.

5. The composition of claim 4 wherein said di-tail fabric softener active, mono-tail fabric softener active and ion pair fabric softener actives are selected from the group consisting of:
a) materials having Formula (1) below 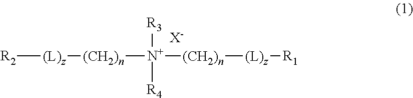
wherein:
(i) R₁ and R₂ are each independently a C₁₁-C₁₇ hydrocarbon;
(ii) R₃ and R₄ are each independently selected from the group consisting of C₁-C₂ hydrocarbon, C₁-C₂ hydroxy substituted hydrocarbon;
(iii) each n is independently an integer from 1 to 2;
(iv) L is selected from the group consisting of —C(O)O—, —C(O)—, —O—(O)C—;
(v) each z is independently 0 or 1; and
(vi) X⁻ is a softener-compatible anion, selected from the group consisting of chloride, bromide, methylsulfate, ethylsulfate, and methyl sulfonate
b) materials having Formula (2) below 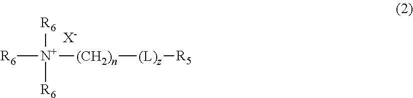
wherein
(i) R₅ is a C₁₁-C₁₇ hydrocarbon;
(ii) each R₆ is independently selected from the group consisting of C₁-C₂ hydrocarbon, C₁-C₂ hydroxy substituted hydrocarbon;
(iii) n is an integer from 1 to 4;
(iv) L is selected from the group consisting of —C(O)O—, —C(O)—, —O—(O)C—;
(v) z is 0 or 1; and
(vi) X— is a softener-compatible anion, selected from the group consisting of chloride, bromide, methylsulfate, ethylsulfate, and methyl sulfonate
c). materials having Formula (3) below 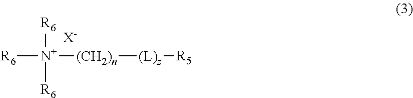
wherein
(i) R₅ is a C₁₁-C₁₇ hydrocarbon;
(ii) each R₆ is independently selected from the group consisting of C₁-C₂ hydrocarbon, C₁-C₂ hydroxy substituted hydrocarbon;
(iii) n is an integer from 1 to 4;
(iv) L is selected from the group consisting of —C(O)O—, —C(O)—, —O—(O)C—;
(v) z is 0 or 1; and
(vi) X— is a softener-compatible anion, selected from the group consisting of chloride, bromide, methylsulfate, ethylsulfate, and methyl sulfonate or anionic surfactant comprising a C₆-C₁₈ hydrocarbon.

6. The composition of claim 3 wherein for Formula 3, X— is a C₆-C₂₄ hydrocarbon that is an anionic surfactant.

7. The composition of claim 6 wherein said anionic surfactant is selected from the group consisting of a C₆-C₂₄ alkyl benzene sulfonate surfactant; a C₆-C₂₄ branched-chain and random alkyl sulfate surfactant; a C₆-C₂₄ alkyl alkoxy sulfate surfactant, having an average degree of alkoxylation of from 1 to 30, wherein the alkoxy moiety comprises a C₂ to C₄ chain; a mid-chain branched alkyl sulfate surfactant; a mid-chain branched alkyl alkoxy sulfate surfactant having an average degree of alkoxylation of from 1 to 30, wherein the alkoxy moiety comprises a C₂ to C₄ chain; a C₆-C₂₄ alkyl alkoxy carboxylates comprising an average degree of alkoxylation of from 1 to 5; a C₆-C₂₄ methyl ester sulfonate surfactant, a C₁₀-C₂₄ alpha-olefin sulfonate surfactant, a C₆-C₂₄ sulfosuccinate surfactant, and a mixture thereof.

8. A composition according to claim 1 wherein P is a polyamine and each hydrophobic moiety has, independently, the formula
K_{q}W
wherein
K is selected from the group consisting of 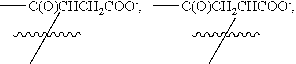
—C(O)O—, —C(O)—, —O—(O)C—, —NR—C(O)—, —C(O)—NR— wherein R is hydrogen or methyl; —(CH₂CH₂O)—, —(CH₂CH₂O)₂—, —(CH₂CH₂O)₃—, —(CH₂CH₂O)₄— and the index q is 0 or 1 and W comprises one of the moieties Z or B; wherein
Z is selected from the group consisting of C₂- to C₂₆-alkyl, C₂- to C₂₆-alkenyl, C₂- to C₂₆-hydroxyalkyl, C₂- to C₂₆-hydroxyalkenyl, C₂- to C₂₆-alkylcarboxyl; and C₂- to C₂₆-aryl, polypropylene, polypropylene oxide, and polyethylene oxide;
B is selected from the group consisting of polyisobutylene, with the proviso that when the hydrophobic moiety is B, the index q equals 1.

9. A composition according to claim 8 wherein said polyamine comprises one or more moieties selected from the group consisting of vinyl foramide, vinyl acetate, acrylate, diallyl dimethyl ammonium chloride, vinylpyrrolidone and mixtures thereof.

10. A composition according to claim 1 wherein P is a polyamine selected from the group consisting of linear poly(ethyleneimine), branched poly(ethyleneimine), linear poly(vinylamine), branched poly(vinylamine), linear poly(allyamine), branched poly(allyamine) and poly(amidoamine).

11. A composition according to claim 10 where in the polyamine is a branched poly(ethyleneimine).

12. A composition according to claim 11 wherein said branched poly(ethyleneimine) has a number average molecular weight of from about 600 Da to 750000 Da.

13. A composition according to claim 8 wherein P is a branched poly (ethyleneimine).

14. A composition according to claim 8 wherein P is poly(vinylamine).

15. A composition according to claim 14 wherein said poly(vinylamine) has a number average molecular weight of from about 10,000 Da to 360000 Da.

16. A composition according to claim 1 wherein said hydrophobically modified cationic polymer is selected from the group consisting of hydrophobically modified cationic polymers comprising the following units: 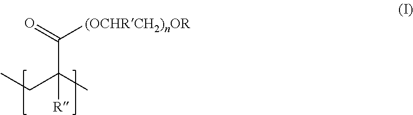
where
R is a C₆-C₅₀ alkyl,
R′ is H or a C₁-C₄ alkyl,
R″ is H or methyl,
n is an integer from 0 to 100; 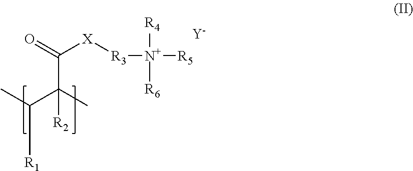
where
R₁ is H or a C₁-C₄ alkyl,
R₂ is H or methyl,
R₃ is a C₁-C₄ alkyl,
R₄, and R₅ are each independently H or a C₁-C₃₀ alkyl,
R₆ is H or a C₁-C₂ alkyl,
X is —O— or —NH— and
Y is a suitable counter ion,
or where
R₁ is H or a C₁-C₄ alkyl,
R₂ is H or methyl
R₃ is a C₁-C₄ linear alkyl,
R₄, and R₅ are each independently H or a C₁-C₃₀ alkyl,
R₆ is methyl
when at least one of R₄ and R₅ are a C₆-C₃₀ alkyl the repeat unit is hydrophobically modified, or R₄ or R₅ is a C₁₂-C₁₈ alkyl and the remaining R₄ or R₅ is methyl with proviso that total number of carbon atoms in R₄ and R₅, does not exceed 24,
X is —O— or —NH— and
Y is Cl; Br; I; hydrogensulfate or methosulfate.
or where
R₁ is H or a C₁-C₄ alkyl,
R₂ is H or methyl,
R₃ is a C₁-C₄ alkyl,
R₄ and R₅ are each independently H or a C₁-C₃₀ alkyl,
R₆ is H or a C₁-C₂ alkyl,
when R₄ and R₅ are H or a C₁-C₅ alkyl the repeat unit is not hydrophobically modified,
X is —O— or —NH— and
Y is a suitable counter ion.

17. The composition of claim 16, wherein for Structure II at least one of R₄ and R₅ are a C₆-C₃₀ alkyl and the total number of carbon atoms in R₄ and R₅ does not exceed 24.

18. The composition of claim 17, wherein for Structure II one of R₄ and R₅ is a C₁₂-C₁₈ alkyl and the total number of carbon atoms in R₄ and R₅, does not exceed 24.

19. The composition of claim 18, wherein for Structure II one of R₄ and R₅ is a C₁₂-C₁₈ alkyl and the remaining R₄ or R₅ is methyl.

20. The composition of claim 16, wherein for Structure II R₄ and R₅ are H or a C₁-C₅ alkyl, or R₄ and R₅ are methyl.

21. A method for making a liquid fabric enhancer composition comprising: combining a hydrophobically modified cationic polymer wherein said hydrophobically modified cationic polymer has the formula PS wherein P is selected from the group consisting a polyamine, a polyacrylamide, a polyacrylate, a polyvinylpyrrolidone and mixtures thereof and S is a hydrophobic moiety and the index x is an integer from 1 to an integer that is equal to the sum of the nitrogen atoms and oxygen atoms in P and fabric softener active.

22. A method of treating a fabric comprising contacting the fabric with a laundry care composition comprising the fabric enhancer composition according to claim 1.
